(19) United States
(12) Patent Application Publication
(10) Pub. No.: US 2019/0081988 A1
(43) Pub. Date: Mar. 14, 2019

(54) SECURITY MANAGEMENT APPARATUS, CENTRAL SECURITY MANAGEMENT APPARATUS, SECURITY MANAGEMENT METHOD, AND COMPUTER READABLE MEDIUM

(71) Applicant: Mitsubishi Electric Corporation, Tokyo (JP)

(72) Inventors: Tomonori NEGI, Tokyo (JP); Kiyoto KAWAUCHI, Tokyo (JP); Junko NAKAJIMA, Tokyo (JP); Yukio IZUMI, Tokyo (JP); Hiroyuki SAKAKIBARA, Tokyo (JP); Shigeki KITAZAWA, Tokyo (JP); Kazuhiro ONO, Tokyo (JP); Takeshi ASAI, Tokyo (JP); Hideaki IJIRO, Tokyo (JP); Hiroki NISHIKAWA, Tokyo (JP)

(73) Assignee: Mitsubishi Electric Corporation, Tokyo (JP)

(21) Appl. No.: 16/081,325

(22) PCT Filed: Jun. 1, 2016
(86) PCT No.: PCT/JP2016/066270

§ 371 Date: Aug. 30, 2018

(51) Int. Cl. H04L 29/06; G06F 21/55; G06F 17/30

(52) U.S. Cl. CPC H04L 63/205; H04L 63/1416; G06F 17/30961; G06F 21/554; G06F 21/552; H04L 63/1441

(57) ABSTRACT

A second communication unit (411) of a security management apparatus (201) externally receives dependency information (412) indicating a dependence relation between information assets individually held by a first system and a second system. Then, a selection unit (415) of the security management apparatus (201) selects a security measure to be implemented, from among candidates for a security measure against a threat to an information asset held by the first system, in accordance with a dependence relation indicated by the dependency information (412) received by the second communication unit (411).

### TECHNICAL FIELD

The present invention relates to a security management apparatus, a central security management apparatus, a security management method, and a security management program.

### BACKGROUND ART

Patent Literature 1 describes a technique for presenting a measure against a threat based on a measure cost, a remaining risk, and a newly derived risk by identifying a threat that causes a state change between individual nodes from a node indicating an initial state to a node in a state in which damage has occurred via a node in a transition state.

Patent Literature 2 describes a technique for activation or deactivation of a security policy in real time against a detected attack based on a success probability that is a probability of realizing an attack objective, an impact of the attack objective on a security level and a QoS level, and a cost impact associated with the attack. QoS is an abbreviation for quality of service.

Patent Literature 3 describes a technique for specifying an asset that is affected by a change in changing a configuration of a system by adding assets or the like, and displaying a measure policy against a threat that occurs.

### CITATION LIST

### Patent Literature

### Patent Literature 1: JP 2009-110177 A

### Patent Literature 2: JP 2013-525927 A

### Patent Literature 3: JP 2005-258512 A

### SUMMARY OF INVENTION

### Technical Problem

In recent years, a SoS with complicated relationships among multiple different systems, such as a smart factory, a smart building, and a smart house, have expanded, and are becoming an important infrastructure indispensable to daily life. SoS is an abbreviation for system of systems. A SoS is a huge system that is a combination of multiple systems having operational independence and management independence. In the world of SoSs, there is concern that a minor obstacle in a certain system will bring out various factors, and cause a large impact on other system, that is, a butterfly effect. As a result of measures taken against a threat caused in a certain system, the butterfly effect may cause other system to be down, causing serious damage.

In a SoS, multiple systems each having operational independence and management independence are combined through the Internet and have a complicated relationship. With each system, a situation changes every moment with a movement of objects such as people and personal computers, and with generation and deletion of information assets, and threats always newly occur or disappear. Therefore, in each system, it is necessary to always recognize the situation of the system in real time, perform security analysis, and implement a security measure against the recognized threat. In addition, it is necessary to grasp a dependence relation with other system and implement a security measure that does not cause an impact on other system.

The technique described in Patent Literature 1 comprehensively analyzes security risks in one closed system and presents measures thereof. This technique does not consider a dependence relation with other system and does not consider an impact caused by a security measure on other system in an environment like a SoS. Therefore, in environments like a SoS, a proposed measure may have a large impact on other system.

The technique described in Patent Literature 2 is to take a measure against attacks occurring in one closed system in real time, based on a success probability of attacks, an impact of an attack objective, and a cost impact. Therefore, even this technique does not consider a dependence relation with other system and does not consider an impact caused by a security measure on other system in an environment like a SoS.

In the technique described in Patent Literature 3, an impact on information assets in one closed system is merely taken into consideration. Therefore, even this technique does not consider a dependence relation with other system and does not consider an impact caused by a security measure on other system in an environment like a SoS.

Thus, conventionally, a technique for presenting and implementing a security measure is only targeted at one closed system having independence of operation and management, but is not targeted at one large system in which multiple different systems having independence of operation and management have a complicated relationship with each other. That is, a dependence relation with other system is not taken into consideration, and a security measure implemented in a certain system may cause a large impact on other system.

An object of the present invention is to enable selection of a security measure, as a security measure to be implemented in a certain system, that does not cause a large impact on other system.

### Solution to Problem

According to one aspect of the present invention, a security management apparatus includes:

a communication unit to externally receive dependency information indicating a dependence relation among information assets individually held by a first system and one or more second systems different from the first system; and

a selection unit to select a security measure to be implemented from candidates for a security measure against a threat to an information asset held by the first system, in accordance with a dependence relation indicated by dependency information received by the communication unit.

### Advantageous Effects of Invention

In the present invention, from candidates for a security measure against a threat to an information asset held by a first system, a security measure to be implemented is selected in accordance with a dependence relation between information assets separately held by the first system and a second system. Therefore, as a security measure to be implemented in the first system, it is possible to select a security measure that does not cause a large impact on the second system.

### BRIEF DESCRIPTION OF DRAWINGS

FIG. 1 is a block diagram illustrating a configuration of a SoS according to a first embodiment.

FIG. 2 is a block diagram illustrating a detailed configuration of the SoS according to the first embodiment.

FIG. 3 is a block diagram illustrating a configuration of a device according to the first embodiment.

FIG. 4 is a block diagram illustrating a configuration of a security management apparatus according to the first embodiment.

FIG. 5 is a diagram illustrating an example of a security measure list according to the first embodiment.

FIG. 6 is a diagram illustrating an example of a relation tree of information assets according to the first embodiment.

FIG. 7 is a sequence diagram illustrating a communication procedure of the SoS according to the first embodiment.

FIG. 8 is a flowchart illustrating an operation of a device according to the first embodiment.

FIG. 9 is a flowchart illustrating an operation of the security management apparatus according to the first embodiment.

FIG. 10 is a flowchart illustrating an operation of the security management apparatus according to the first embodiment.

FIG. 11 is a flowchart illustrating an operation of the security management apparatus according to the first embodiment.

FIG. 12 is a diagram illustrating an example of a security measure evaluation table according to the first embodiment.

FIG. 13 is a block diagram illustrating a detailed configuration of a SoS according to a second embodiment.

FIG. 14 is a block diagram illustrating a configuration of a security management apparatus according to the second embodiment.

FIG. 15 is a diagram illustrating an example of a security measure list according to the second embodiment.

FIG. 16 is a diagram illustrating an example of a relation tree of information assets according to the second embodiment.

FIG. 17 is a block diagram illustrating a configuration of a central security management apparatus according to the second embodiment.

FIG. 18 is a sequence diagram illustrating a communication procedure of the SoS according to the second embodiment.

FIG. 19 is a flowchart illustrating an operation of the security management apparatus according to the second embodiment.

FIG. 20 is a flowchart illustrating an operation of the central security management apparatus according to the second embodiment.

FIG. 21 is a flowchart illustrating an operation of the security management apparatus according to the second embodiment.

FIG. 22 is a sequence diagram illustrating a communication procedure of the SoS according to the second embodiment.

FIG. 23 is a flowchart illustrating an operation of the security management apparatus according to the second embodiment.

FIG. 24 is a flowchart illustrating an operation of the central security management apparatus according to the second embodiment.

FIG. 25 is a flowchart illustrating an operation of the security management apparatus according to the second embodiment.

FIG. 26 is a flowchart illustrating an operation of the security management apparatus according to the second embodiment.

FIG. 27 is a diagram illustrating an example of a security measure evaluation table according to the second embodiment.

FIG. 28 is a block diagram illustrating a configuration of a security management apparatus according to a third embodiment.

FIG. 29 is a block diagram illustrating a configuration of a central security management apparatus according to the third embodiment.

FIG. 30 is a sequence diagram illustrating a communication procedure of a SoS according to the third embodiment.

FIG. 31 is a flowchart illustrating an operation of the security management apparatus according to the third embodiment.

FIG. 32 is a flowchart illustrating an operation of the central security management apparatus according to the third embodiment.

FIG. 33 is a sequence diagram illustrating a communication procedure of the SoS according to the third embodiment.

FIG. 34 is a flowchart illustrating an operation of the central security management apparatus according to the third embodiment.

FIG. 35 is a flowchart illustrating an operation of the security management apparatus according to the third embodiment.

FIG. 36 is a sequence diagram illustrating a communication procedure of the SoS according to the third embodiment.

FIG. 37 is a sequence diagram illustrating a communication procedure of the SoS according to the third embodiment.

FIG. 38 is a sequence diagram illustrating a communication procedure of the SoS according to the third embodiment.

FIG. 39 is a flowchart illustrating an operation of the central security management apparatus according to the third embodiment.

FIG. 40 is a flowchart illustrating an operation of the central security management apparatus according to the third embodiment.

FIG. 41 is a sequence diagram illustrating a communication procedure of a SoS according to a fourth embodiment.

FIG. 42 is a flowchart illustrating an operation of a device according to the fourth embodiment.

FIG. 43 is a flowchart illustrating an operation of a security management apparatus according to the fourth embodiment.

FIG. 44 is a flowchart illustrating an operation of the security management apparatus according to the fourth embodiment.

FIG. 45 is a sequence diagram illustrating a communication procedure of the SoS according to the fourth embodiment.

FIG. 46 is a flowchart illustrating an operation of the security management apparatus according to the fourth embodiment.

FIG. 47 is a flowchart illustrating an operation of a device according to the fourth embodiment.

### DESCRIPTION OF EMBODIMENTS

Hereinafter, embodiments of the present invention will be described with reference to the drawings. It should be noted that, in the individual drawings, same or corresponding parts are denoted by the same reference numerals. In the description of the embodiments, the description of the same or corresponding parts will be omitted or simplified as necessary.

### First Embodiment

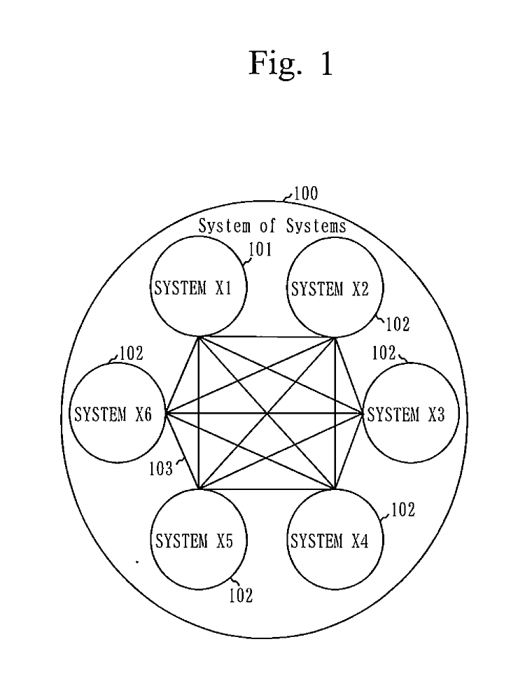

The present embodiment will be described with reference to FIGS. 1 to 12.

*** Description of Configuration ***

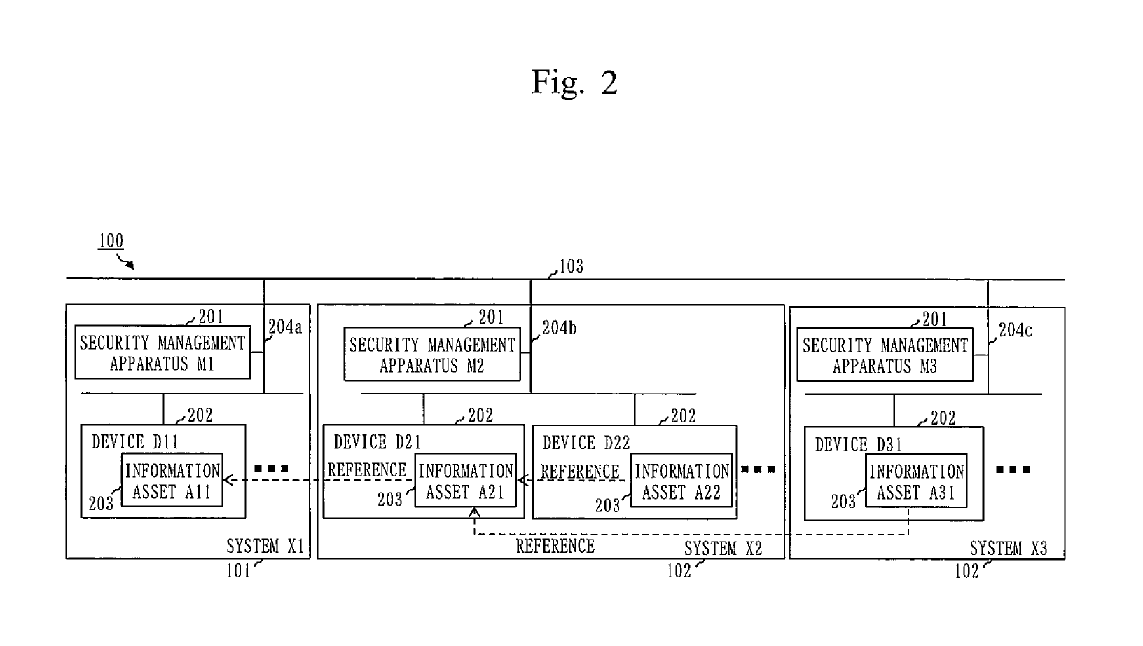

With reference to FIGS. 1 and 2, a configuration of a SoS 100 according to the present embodiment will be described.

The SoS 100 includes a plurality of systems each having operational independence and management independence. The number of systems may be two or more, but six in this embodiment.

When any one of the plurality of systems is regarded as a first system 101, the rest can be regarded as one or more second systems 102 different from the first system 101. In the present embodiment, there are a system X1 corresponding to the first system 101, and systems X2, X3, X4, X5, and X6 corresponding to the second systems 102. It should be noted that any of the systems X2, X3, X4, X5, and X6 can be handled as the first system 101, and the rest of the systems as the second systems 102.

Each system includes a security management apparatus 201 and a plurality of devices 202.

The systems X1, X2, X3, X4, X5, and X6 are mutually connected via the Internet 103 and have a complicated relationship. In each system, a situation changes every moment with a movement of objects such as people and the devices 202 and with generation and deletion of an information asset 203, and threats always newly occur or disappear. Therefore, in each system, the security management apparatus 201 always recognizes the situation of the system in real time, performs security analysis, and implements a security measure against the recognized threat. In addition, in the present embodiment, the security management apparatus 201 grasps a dependence relation with other system and implements a security measure that does not cause an impact on other system.

In each system, the plurality of devices 202 and the security management apparatus 201 are connected via a LAN. Specifically, in the system X1, a device D11 and a security management apparatus M1 are connected via a LAN 204a. In the system X2, devices D21 and D22 and a security management apparatus M2 are connected via a LAN 204b. In the system X3, a device D31 and a security management apparatus M3 are connected via a LAN 204c. LAN is an abbreviation for local area network. The LAN is actually formed by various network devices, but they are omitted in FIG. 2.

Each of the devices 202 holds the information asset 203. Specifically, information assets A11, A21, A22, and A31 exist in the devices D11, D21, D22, and D31, respectively. In FIG. 2, only one information asset 203 is illustrated per one device 202, but a large number of information assets 203 are actually held in one device 202. The information asset 203 is a concept including not only information itself, but also a mechanism to handle the information. Therefore, not only documents and data but also hardware and software also correspond to the information asset 203.

The information asset A21 on the device D21 of the system X2 is generated with reference to the information asset A11 on the device D11 of the system X1. That is, the information asset A21 is the information asset 203 dependent on the information asset A11. Further, the information asset A22 on the device D22 of the system X2 is generated with reference to the information asset A21 on the device D21 of the system X2. The information asset A31 on the device D31 of the system X3 is generated with reference to the information asset A21 on the device D21 of the system X2. That is, the information assets A22 and A31 are the information assets 203 dependent on the information asset A21.

In the present embodiment, the security management apparatus 201 of the first system 101 obtains a dependence relation with other system corresponding to the second system 102 from a connection of the information assets 203, considers the dependence relation with other system, and selects and implements an optimum security measure so as not to cause an impact on other system as much as possible.

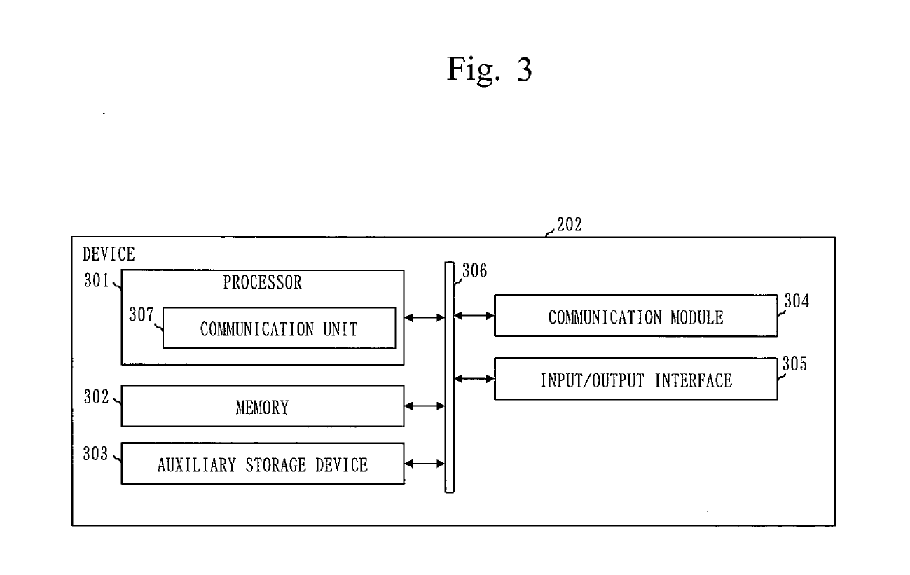

With reference to FIG. 3, a configuration of the device 202 according to the present embodiment will be described.

The device 202 is a computer. The device 202 includes a processor 301, and includes other hardware such as a memory 302, an auxiliary storage device 303, a communication module 304, and an input/output interface 305. The processor 301 is connected to other hardware via a bus 306, and controls this other hardware.

The device 202 includes, as a functional element, a communication unit 307 to communicate with the security management apparatus 201. A function of the communication unit 307 is realized by software.

The processor 301 is an IC to perform processing. IC is an abbreviation for integrated circuit. Specifically, the processor 301 is a CPU. CPU is an abbreviation for central processing unit.

Specifically, the memory 302 is a flash memory or a RAM. RAM is an abbreviation for random access memory.

In the auxiliary storage device 303, a program for realizing the function of the communication unit 307 is stored. This program is loaded into the memory 302 and executed by the processor 301. The auxiliary storage device 303 also stores an OS. OS is an abbreviation for operating system. The processor 301 executes a program for realizing the function of the communication unit 307 while executing the OS. It should be noted that a part or the whole of the program for realizing the function of the communication unit 307 may be incorporated in the OS. Specifically, the auxiliary storage device 303 is an HDD or a flash memory. HDD is an abbreviation for hard disk drive.

The communication module 304 includes a receiver to receive data and a transmitter to transmit data. Specifically, the communication module 304 is a communication chip or an NIC. NIC is an abbreviation for network interface card.

The input/output interface 305 is a port connected with an input device or an output device that is not illustrated. Specifically, the input/output interface 305 is a USB terminal. USB is an abbreviation for universal serial bus. Specifically, the input device is a mouse, a keyboard, or a touch panel. Specifically, the output device is an LCD. LCD is an abbreviation for liquid crystal display.

The device 202 may include a plurality of processors substituting for the processor 301. These plurality of processors share execution of the program for realizing the function of the communication unit 307. Similarly to the processor 301, each processor is an IC to perform processing.

Information, data, a signal value, and a variable value that indicate a processing result of the communication unit 307 are stored in the memory 302, the auxiliary storage device 303, or a register or a cache memory in the processor 301.

The program for realizing the function of the communication unit 307 may be stored in a portable recording medium such as a magnetic disk or an optical disk.

It should be noted that the function of the communication unit 307 may be realized by a combination of software and hardware. Alternatively, the function of the communication unit 307 may be realized by hardware. Specifically, an entity of the communication unit 307 may be the same as the communication module 304.

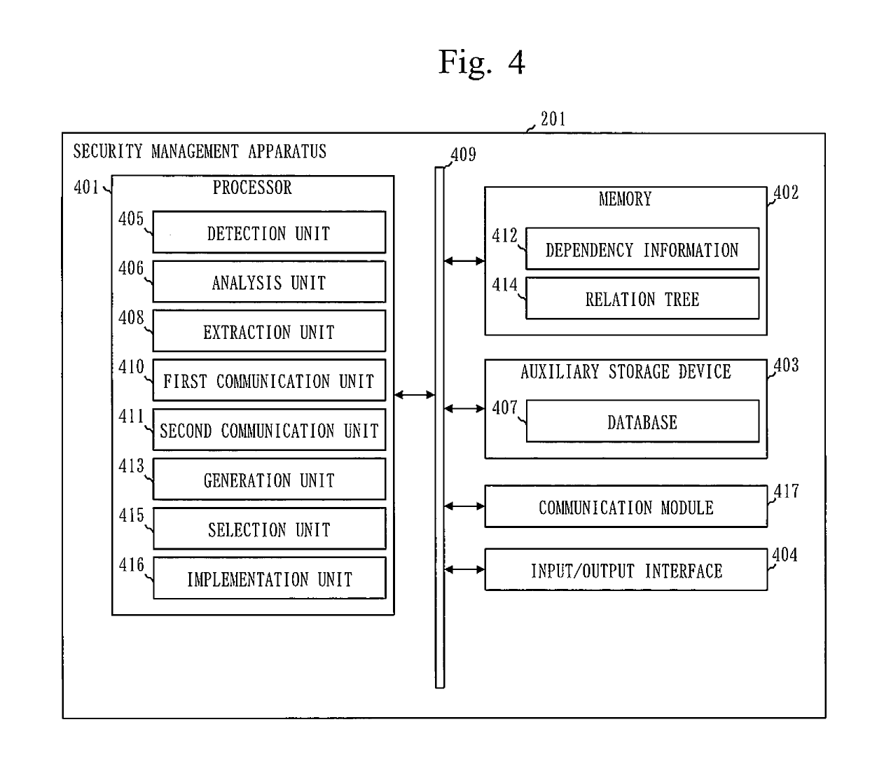

With reference to FIG. 4, a configuration of the security management apparatus 201 according to the present embodiment will be described.

The security management apparatus 201 is a computer. The security management apparatus 201 includes a processor 401, and includes other hardware such as a memory 402, an auxiliary storage device 403, an input/output interface 404, and a communication module 417. The processor 401 is connected to other hardware via a bus 409, and controls this other hardware.

The security management apparatus 201 includes, as functional elements, a detection unit 405, an analysis unit 406, an extraction unit 408, a first communication unit 410, a second communication unit 411, a generation unit 413, a selection unit 415, and an implementation unit 416. A function of a “unit”, such as the detection unit 405, the analysis unit 406, the extraction unit 408, the first communication unit 410, the second communication unit 411, the generation unit 413, the selection unit 415, or the implementation unit 416, is realized by software.

The processor 401 is an IC to perform processing. Specifically, the processor 401 is a CPU.

The memory 402 stores dependency information 412 that is information related to an access to the information asset 203, and a relation tree 414 that is tree-structured data representing a connection of the information assets 203. Specifically, the memory 402 is a flash memory or a RAM.

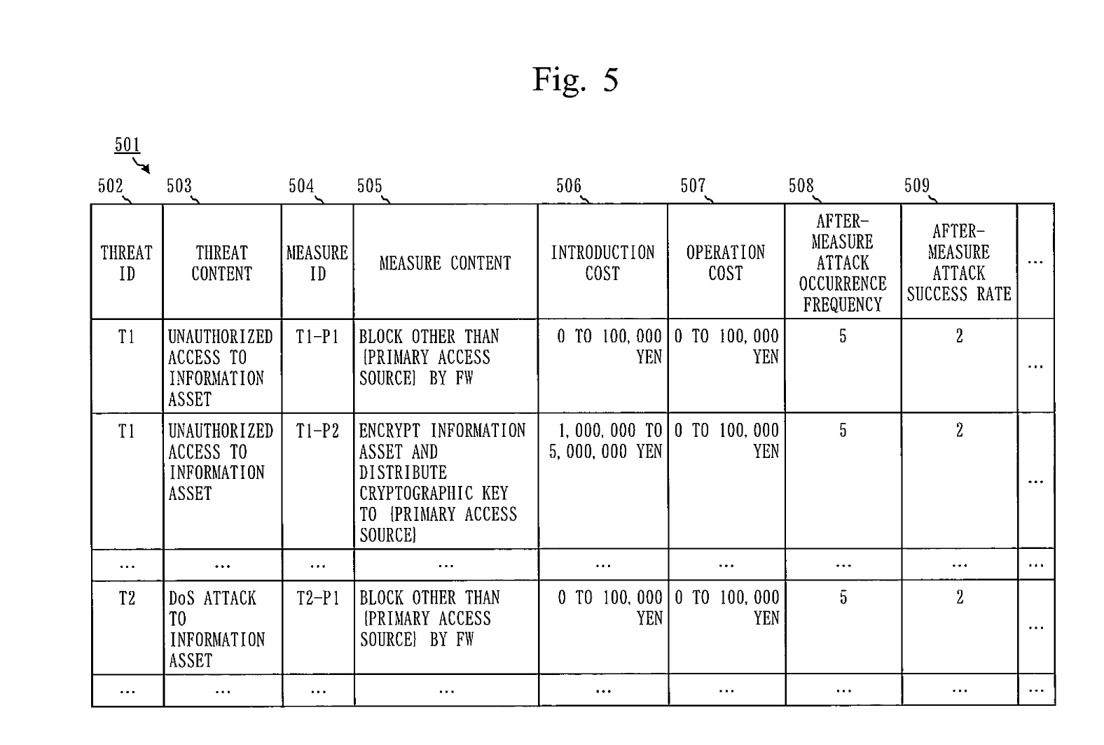

The auxiliary storage device 403 stores a program for realizing the function of the “unit” of the security management apparatus 201. This program is loaded into the memory 402 and executed by the processor 401. The auxiliary storage device 403 also stores an OS. The processor 401 executes the program for realizing the function of the “unit” of the security management apparatus 201 while executing the OS. It should be noted that a part or the whole of the program for realizing the function of the “unit” of the security management apparatus 201 may be incorporated in the OS. The auxiliary storage device 403 also stores a database 407 that holds a security measure list 501 as illustrated in FIG. 5. Specifically, the auxiliary storage device 403 is an HDD or a flash memory.

The input/output interface 404 is a port connected with an input device or an output device that is not illustrated. Specifically, the input/output interface 404 is a USB terminal. Specifically, the input device is a mouse, a keyboard, or a touch panel. Specifically, the output device is an LCD.

The communication module 417 includes a receiver to receive data and a transmitter to transmit data. Specifically, the communication module 417 is a communication chip or an NIC.

The security management apparatus 201 may include a plurality of processors substituting for the processor 401. These plurality of processors share execution of the program for realizing the function of the “unit” of the security management apparatus 201. Similarly to the processor 401, each processor is an IC to perform processing.

Information, data, a signal value, and a variable value that indicate a processing result of the “unit” of the security management apparatus 201 are stored in the memory 402, the auxiliary storage device 403, or a register or a cache memory in the processor 401.

The program for realizing the function of the “unit” of the security management apparatus 201 may be stored in a portable recording medium such as a magnetic disk or an optical disk.

The detection unit 405 is a functional element to grasp a network configuration and a system configuration in the system. The analysis unit 406 is a functional element to perform security analysis on the system and identify a threat. The extraction unit 408 is a functional element to extract a security measure against a threat identified by the analysis unit 406, from the security measure list 501 registered in the database 407. The first communication unit 410 is a functional element to communicate with the device 202 by using the communication module 417, and to receive the dependency information 412 from the device 202 when the device 202 accesses the information asset 203. The second communication unit 411 is a functional element to communicate with a security management apparatus 201 of other system by using the communication module 417, and to share the dependency information 412 with the security management apparatus 201 of other system. The dependency information 412 received by the first communication unit 410 and the second communication unit 411 is stored and managed in the memory 402. The generation unit 413 is a functional element to generate a relation tree 414 of the information asset 203 based on the dependency information 412 stored in the memory 402. The relation tree 414 generated by the generation unit 413 is stored and managed in the memory 402. The selection unit 415 is a functional element to determine details of a security measure from the security measure extracted by the extraction unit 408 and from the relation tree 414 stored in the memory 402, and to select an optimum security measure in accordance with a security measure policy specified by an administrator. The implementation unit 416 is a functional element to implement the optimum security measure selected by the selection unit 415.

FIG. 5 illustrates an example of the security measure list 501 registered in the database 407. In this example, the security measure list 501 has columns such as a threat ID 502, a threat content 503, a measure ID 504, a measure content 505, an introduction cost 506, an operation cost 507, an after-measure attack occurrence frequency 508, and an after-measure attack success rate 509. In the security measure list 501, the threat ID 502 is given for each threat content 503, the measure content 505 is defined for each threat content 503, and the measure ID 504, the introduction cost 506, the operation cost 507, the after-measure attack occurrence frequency 508, and the after-measure attack success rate 509 are defined for each measure content 505.

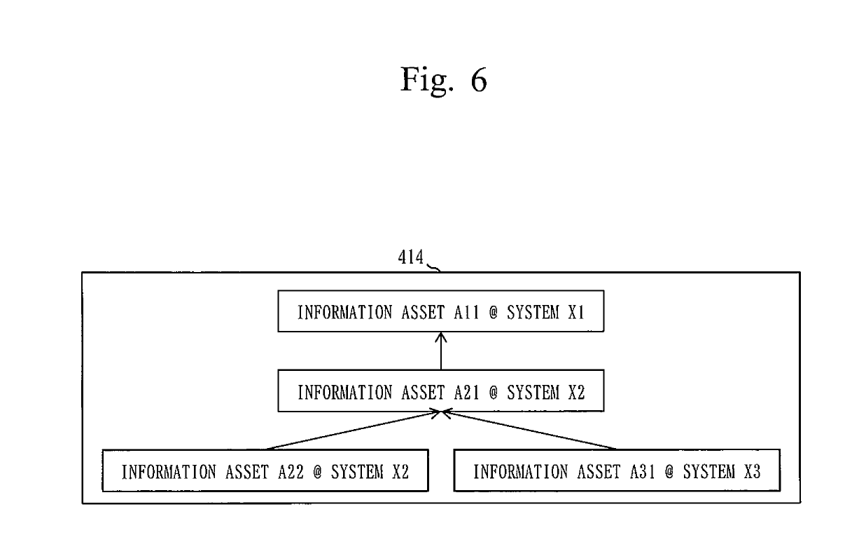

FIG. 6 illustrates an example of the relation tree 414 to be generated by the generation unit 413. In this example, the relation tree 414 indicates that the information asset A22 on the system X2 and the information asset A31 on the system X3 refer to the information asset A21 on the system X2, and that the information asset A21 on the system X2 refers to the information asset A11 on the system X1.

*** Description of Operation ***

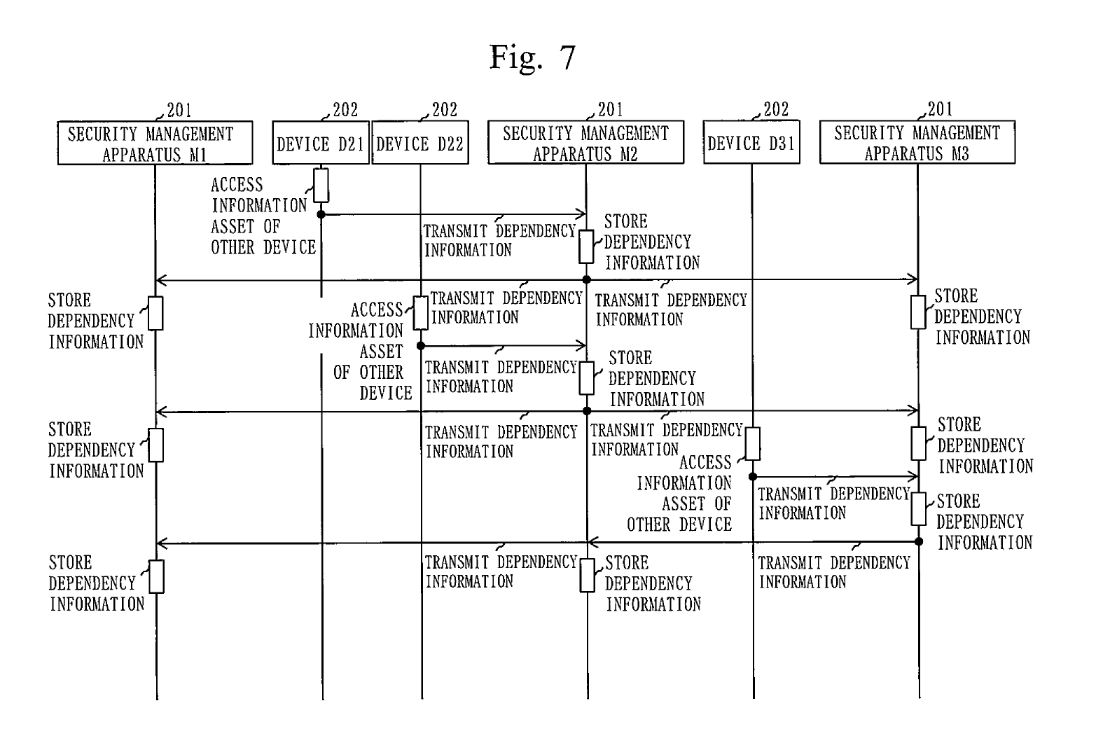

With reference to FIGS. 7 to 12, an operation of the SoS 100 according to the present embodiment will be described. An operation of the security management apparatus 201 according to the present embodiment corresponds to a security management method according to the present embodiment. The operation of the security management apparatus 201 according to the present embodiment corresponds to a processing procedure of a security management program according to the present embodiment.

FIG. 7 illustrates that reference to the information asset 203 is made in the following order, but the order of reference is not limited to this. First, the information asset A21 on the device D21 of the system X2 refers to the information asset A11 on the device D11 of the system X1. Next, the information asset A22 on the device D22 of the system X2 refers to the information asset A21 on the device D21 of the system X2. Finally, the information asset A31 on the device D31 of the system X3 refers to the information asset A21 on the device D21 of the system X2.

Dependency information 412 transmitted and received between the device 202 and the security management apparatus 201 and between the security management apparatuses 201 includes information asset information of a reference source and information asset information of a reference destination. In the present embodiment, the information asset information of the reference source and the information asset information of the reference destination that are included in the dependency information 412 are expressed with an information asset name and a system name in a form such as “information asset A11 @ system X1”, but any other expression may be used. As a specific example, the dependency information 412 may be formed of an information asset name, a host name, and a system name or a domain name. The dependency information 412 may be in any form as long as it can uniquely specify the information asset 203.

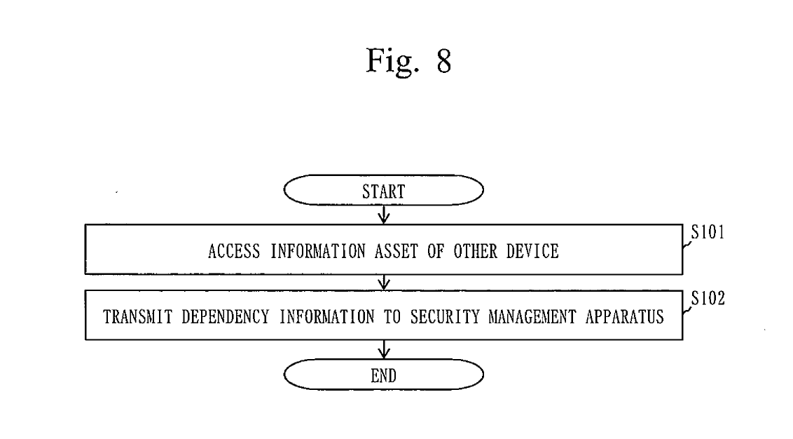

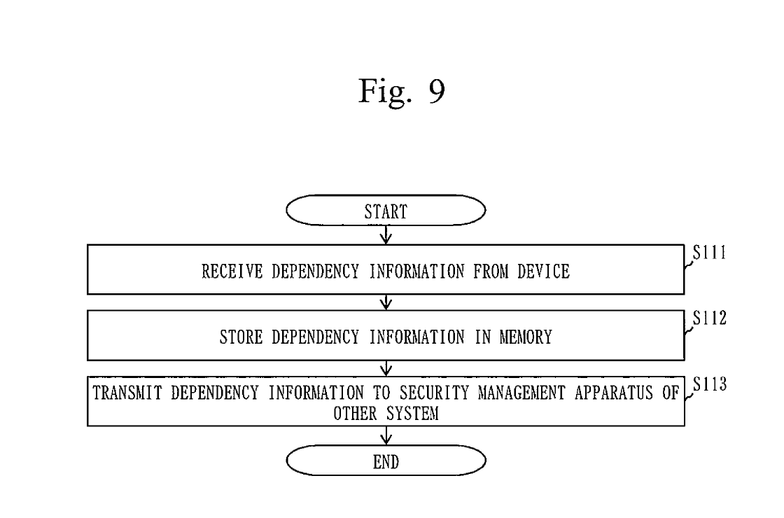

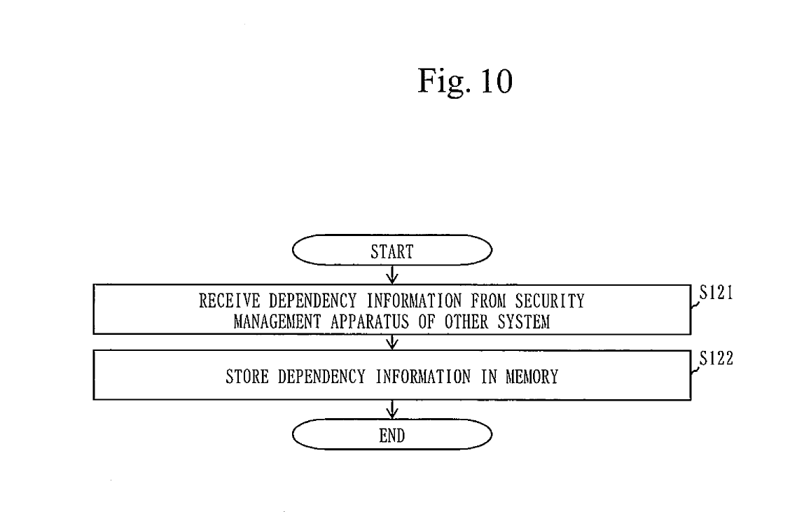

FIG. 8 illustrates an operation of the device 202. FIG. 9 illustrates an operation at a time when the security management apparatus 201 receives the dependency information 412 from the device 202. FIG. 10 illustrates an operation at a time when the security management apparatus 201 receives the dependency information 412 from a security management apparatus 201 of other system.

In step S101 of FIG. 8, in order to refer to the information asset A11 on the device D11 of the system X1, the information asset A21 on the device D21 of the system X2 accesses the information asset A11. In step S102 of FIG. 8, a communication unit 307 of the device D21 transmits dependency information 412 “information asset A21 @ system X2 to information asset A11 @ system X1” to the security management apparatus M2 of the system X2.

In step S111 of FIG. 9, a first communication unit 410 of the security management apparatus M2 receives the dependency information 412 “information asset A21 @ system X2 to information asset A11 @ system X1” from the device D21. In step S112 of FIG. 9, the security management apparatus M2 stores the received dependency information 412 “information asset A21 @ system X2 to information asset A11 @ system X1” in a memory 402. In step S113 of FIG. 9, a second communication unit 411 of the security management apparatus M2 transmits the dependency information 412 “information asset A21 @ system X2 to information asset A11 @ system X1” to the security management apparatus M1 of the system X1 and the security management apparatus M3 of the system X3.

In step S121 of FIG. 10, the second communication units 411 of the security management apparatus M1 of the system X1 and of the security management apparatus M3 of the system X3 receive the dependency information 412 “information asset A21 @ system X2 to information asset A11 @ system X1” from the security management apparatus M2 of the system X2. In step S122 of FIG. 10, the security management apparatuses M1 and M3 store the dependency information 412 “information asset A21 @ system X2 to information asset A11 @ system X1” in respective memories 402.

Similarly, in step S101 of FIG. 8, in order to refer to the information asset A21 on the device D21 of the system X2, the information asset A22 on the device D22 of the system X2 accesses the information asset A21. In step S102 of FIG. 8, a communication unit 307 of the device D22 transmits dependency information 412 “information asset A22 @ system X2 to information asset A21 @ system X2” to the security management apparatus M2 of the system X2.

In step S111 of FIG. 9, the first communication unit 410 of the security management apparatus M2 receives the dependency information 412 “information asset A22 @ system X2 to information asset A21 @ system X2” from the device D22. In step S112 of FIG. 9, the security management apparatus M2 stores the received dependency information 412 “information asset A22 @ system X2 to information asset A21 @ system X2” in the memory 402. In step S113 of FIG. 9, the second communication unit 411 of the security management apparatus M2 transmits the dependency information 412 “information asset A22 @ system X2 to information asset A21 @ system X2” to the security management apparatus M1 of the system X1 and the security management apparatus M3 of the system X3.

In step S121 of FIG. 10, second communication units 411 of the security management apparatus M1 of the system X1 and of the security management apparatus M3 of the system X3 receive the dependency information 412 “information asset A22 @ system X2 to information asset A21 @ system X2” from the security management apparatus M2 of the system X2. In step S122 of FIG. 10, the security management apparatuses M1 and M3 store the dependency information 412 “information asset A22 @ system X2 to information asset A21 @ system X2” in the respective memories 402.

Similarly, in step S101 of FIG. 8, in order to refer to the information asset A21 on the device D21 of the system X2, the information asset A31 on the device D31 of the system X3 accesses the information asset A21. In step S102 of FIG. 8, a communication unit 307 of the device D31 transmits dependency information 412 “information asset A31 @ system X3 to information asset A21 @ system X2” to the security management apparatus M3 of the system X3.

In step S111 of FIG. 9, a first communication unit 410 of the security management apparatus M3 receives the dependency information 412 “information asset A31 @ system X3 to information asset A21 @ system X2” from the device D31. In step S112 of FIG. 9, the security management apparatus M3 stores the received dependency information 412 “information asset A31 @ system X3 to information asset A21 @ system X2” in the memory 402. In step S113 of FIG. 9, a second communication unit 411 of the security management apparatus M3 transmits the dependency information 412 “information asset A31 @ system X3 to information asset A21 @ system X2” to the security management apparatus M1 of the system X1 and the security management apparatus M2 of the system X2.

In step S121 of FIG. 10, the second communication units 411 of the security management apparatus M1 of the system X1 and of the security management apparatus M2 of the system X2 receive the dependency information 412 “information asset A31 @ system X3 to information asset A21 @ system X2” from the security management apparatus M3 of the system X3. In step S122 of FIG. 10, the security management apparatuses M1 and M2 store the dependency information 412 “information asset A31 @ system X3 to information asset A21 @ system X2” in the respective memories 402.

In the present embodiment, the dependency information 412 shared and stored among the security management apparatuses M1, M2, and M3 is the same and symmetrical in all the security management apparatuses 201. However, there is no need to transmit irrelevant dependency information 412 to an irrelevant security management apparatus 201, and the dependency information 412 shared and stored among the security management apparatuses M1, M2, and M3 may be different for each security management apparatus 201 and may be asymmetric.

As a specific example, in the present embodiment, since the dependency information 412 “information asset A21 @ system X2 to information asset A11 @ system X1” transmitted from the security management apparatus M2 of the system X2 is unnecessary information for the security management apparatus M3 of the system X3, it does not need to be transmitted to the security management apparatus M3.

Similarly, the security management apparatus M3 may only transmit the dependency information 412 “information asset A31 @ system X3 to information asset A21 @ system X2” to only the security management apparatus M2 of the system X2. However, the information asset A21 refers to the information asset A11 on the device D11 of the system X1. Therefore, the security management apparatus M2 needs to transfer the dependency information 412 “information asset A31 @ system X3 to information asset A21 @ system X2” from the security management apparatus M3, to the security management apparatus M1 of the system X1.

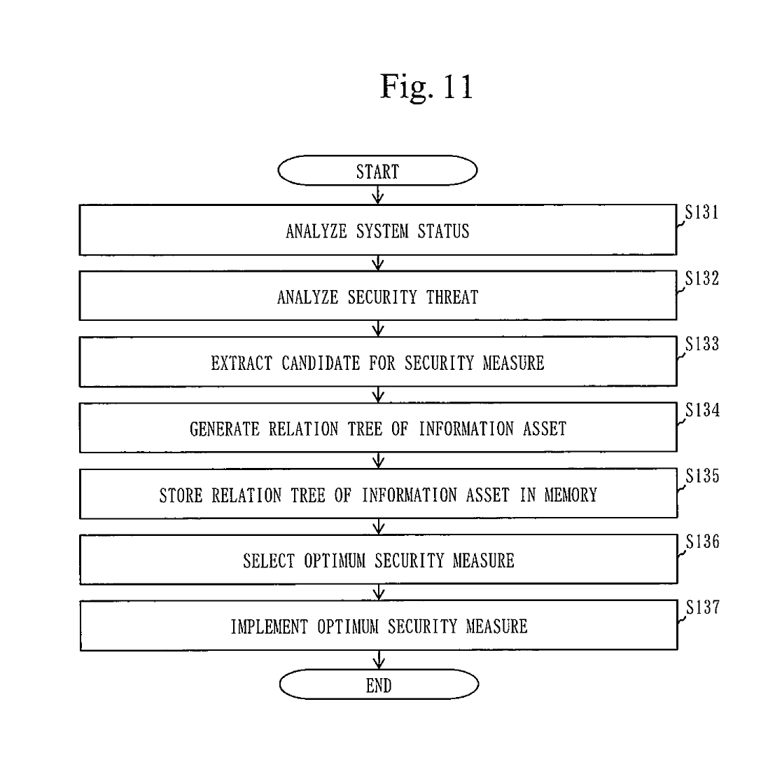

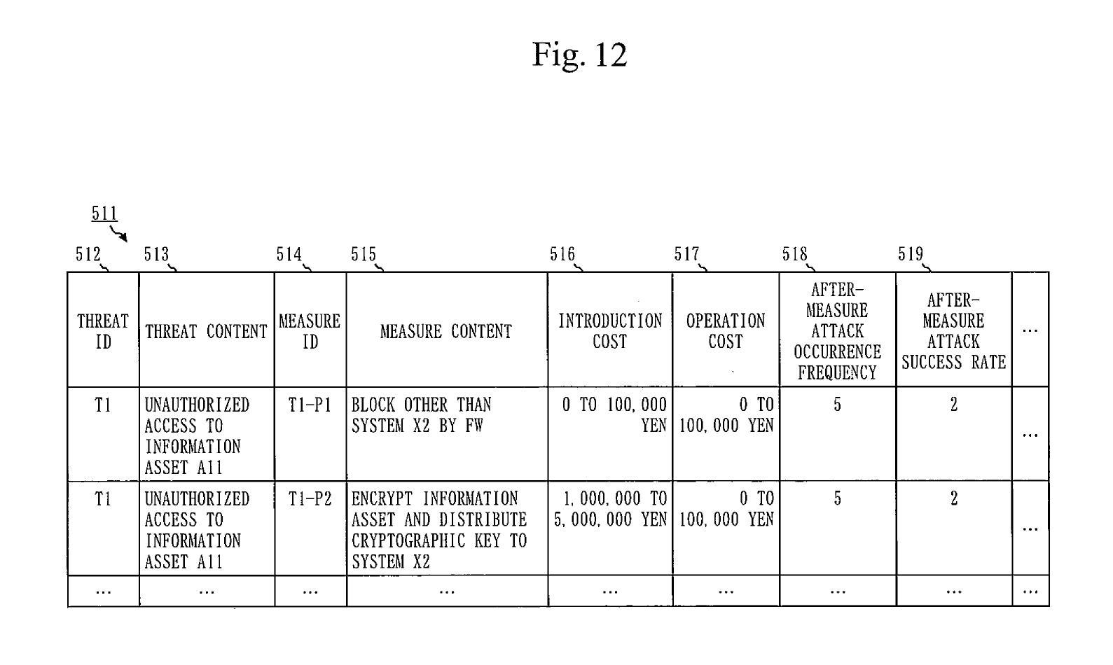

FIG. 11 illustrates an operation at a time when the security management apparatus 201 performs security threat analysis and implements a security measure. FIG. 12 illustrates an example of a security measure evaluation table 511 for the selection unit 415 of the security management apparatus 201 to evaluate a security measure extracted by the extraction unit 408. In this example, the security measure evaluation table 511 has columns such as a threat ID 512, a threat content 513, a measure ID 514, a measure content 515, an introduction cost 516, an operation cost 517, an after-measure attack occurrence frequency 518, and an after-measure attack success rate 519. The threat ID 512, the measure ID 514, the introduction cost 516, the operation cost 517, the after-measure attack occurrence frequency 518, and the after-measure attack success rate 519 are the same as the columns with the same names in the security measure list 501 illustrated in FIG. 5. The threat content 513 and the measure content 515 are more specific contents than the columns with the same names in the security measure list 501 illustrated in FIG. 5.

In step S131 of FIG. 11, a detection unit 405 of the security management apparatus M1 collects information on a status of the system X1, such as a network configuration, a system configuration, and a holding status of an information asset 203, and analyzes a system status based on the information on the status of the system X1. When there is a change in the system status, an analysis unit 406 of the security management apparatus M1 performs security threat analysis based on the information on the status of the system X1, in step S132 of FIG. 11. In step S133 of FIG. 11, an extraction unit 408 of the security management apparatus M1 extracts all candidates for a security measure that can be taken from the security measure list 501 registered in the database 407, based on the threat identified by the analysis unit 406. Here, it is assumed that the analysis unit 406 has found a threat of an unauthorized access to the information asset A11 on the device 1311 of the system X1.

In step S134 of FIG. 11, a generation unit 413 of the security management apparatus M1 generates a relation tree 414 of the information asset 203 based on the dependency information 412 stored in the memory 402. In step S135 of FIG. 11, the generation unit 413 of the security management apparatus M1 stores the relation tree 414 in the memory 402. In step S136 of FIG. 11, a selection unit 415 of the security management apparatus M1 generates a security measure evaluation table 511 including an actual threat content 513 and an actual measure content 515 based on candidates for a security measure extracted by the extraction unit 408 and based on the relation tree 414 stored in the memory 402. Further, the selection unit 415 selects an optimum security measure from the security measure evaluation table 511 in accordance with a security measure policy specified by an administrator. The security measure policy is “an information security measure with the smallest sum of the introduction cost and the operation cost” in this case, but may be “an information security measure with the lowest product of the after-measure attack occurrence frequency and the after-measure attack success rate” and the like.

In the present embodiment, values of the introduction cost 506 and the operation cost 507 in the security measure list 501 registered in the database 407 are fixed values, but can be proportional values of any coefficient obtained from the dependency information 412. As a specific example, a proportional value of the number of primary access sources such as “100,000 yen×{number of primary access sources}}” may be used. By using the proportional value of a coefficient obtained from the dependency information 412, the dependency information 412 can be more effectively utilized.

In step S137 of FIG. 11, an implementation unit 416 of the security management apparatus M1 implements the optimum security measure selected by the selection unit 415. It should be noted that, depending on an optimum security measure, the optimum security measure cannot be automatically implemented by the security management apparatus M1, and, are implemented by an administrator in that case.

*** Description of Effect of Embodiment ***

As described above, in the present embodiment, by obtaining a dependence relation with other system from a connection of the information assets 203 and considering the dependence relation with other system, it is possible to select and implement an optimum security measure so as not to cause an impact on other system. Therefore, it is possible to realize a safe security measure system in which a measure implemented in a certain system does not cause serious damage to other system.

In the present embodiment, the security management apparatus M1 corresponding to the security management apparatus 201 included in the first system 101 shares the dependency information 412 with the security management apparatuses M2 and M3 corresponding to other security management apparatus 201 included in the one or more second systems 102. Specifically, in step S121, a second communication unit 411 of the security management apparatus M1 receives, from the external security management apparatuses M2 and M3, dependency information 412 indicating a dependence relation among the information assets 203 individually held by the system X1 corresponding to the first system 101 and by the systems X2 and X3 corresponding to the second system 102. Then, in step S136, the selection unit 415 of the security management apparatus M1 selects, from candidates for a security measure against a threat to the information asset A11 held by the system X1, a security measure to be implemented in accordance with the dependence relation indicated by the dependency information 412 received by the second communication unit 411.

As described above, in the present embodiment, from the candidates for a security measure for the information asset A11 held by the system X1, a security measure to be implemented is selected in accordance with the dependence relation among the information assets 203 individually held by the systems X1, X2, and X3. Therefore, as a security measure to be implemented in the system X1, it is possible to select a security measure that does not cause a large impact on the systems X2 and X3. That is, according to the present embodiment, from the candidates for a security measure against a threat identified by security analysis, it is possible to select and implement an optimum security measure in consideration of the dependence relation with other system.

In step S136, the selection unit 415 of the security management apparatus M1 selects, as a security measure to be implemented, a security measure that is to limit an access source to the information asset A11 corresponding to the first information asset held by the first system 101, to the second system 102 holding the information asset A21 corresponding to the second information asset dependent on the first information asset, that is, the system X2. Therefore, it is possible to select an optimum security measure that is to prevent an unauthorized access to the information asset A11 without inhibiting an authorized access from the system X2, and to implement the optimum security measure on the system X1.

In step S134, the generation unit 413 of the security management apparatus M1 generates a relation tree 414, which is data to define the dependence relation indicated by the dependency information 412 in a tree structure, from the dependency information 412. In step S136, the selection unit 415 of the security management apparatus M1 refers to the relation tree 414 generated by the generation unit 413, and specifies the dependence relation among the information assets 203 individually held by the systems X1, X2, and X3. Since the dependence relation can be specified by scanning of the tree structure, efficient processing is possible.

In step S133, the extraction unit 408 of the security management apparatus M1 extracts, for each security measure, an index value of each candidate for a security measure against a threat to the information asset A11 held by the system X1, from the database 407 storing index values for selecting the security measure. Specifically, the extraction unit 408 obtains values of the introduction cost 506 and the operation cost 507 of each corresponding candidate from the security measure list 501 of the database 407. In step S136, the selection unit 415 of the security management apparatus M1 selects a security measure whose index value extracted by the extraction unit 408 satisfies a condition, as a security measure to be implemented. Specifically, the selection unit 415 sets, as a security measure to be implemented, a candidate that satisfies a condition that a sum of the introduction cost 506 and the operation cost 507 is the smallest. By appropriately adjusting the condition, it is possible to flexibly respond to various requirements of the system or various demands of a user. It should be noted that, in the present embodiment, the security measure policy, which is information indicating the above condition, is input to the security management apparatus M1 by an administrator, but may be externally received by the second communication unit 411 of the security management apparatus M1 as in other embodiment to be described later.

In step S131, the detection unit 405 of the security management apparatus M1 detects a change in the configuration of the system X1. In step S136, the selection unit 415 of the security management apparatus M1 selects a security measure to be implemented in accordance with not only the dependence relation indicated by the dependency information 412, but also the change detected by the detection unit 405. Therefore, it is possible to select a security measure suitable for a current state.

*** Other Configuration ***

In the present embodiment, the function of the “unit” of the security management apparatus 201 is realized by software. However, as a modification, the function of the “unit” of the security management apparatus 201 may be realized by a combination of software and hardware. That is, a part of the function of the “unit” of the security management apparatus 201 may be realized by an exclusive electronic circuit, and the rest may be realized by software.

Specifically, the exclusive electronic circuit is a single circuit, a composite circuit, a programmed processor, a parallel-programmed processor, a logic IC, a GA, an FPGA, or an ASIC. GA is an abbreviation for gate array. FPGA is an abbreviation for field-programmable gate array. ASIC is an abbreviation for application specific integrated circuit.

The processor 401, the memory 402, and the exclusive electronic circuit are collectively referred to as “processing circuitry”. That is, regardless of whether the function of the “unit” of the security management apparatus 201 is realized by software or realized by a combination of software and hardware, the function of the “unit” of the security management apparatus 201 is realized by the processing circuitry.

The “unit” may be replaced with “step”, “procedure”, or “processing”.

### Second Embodiment

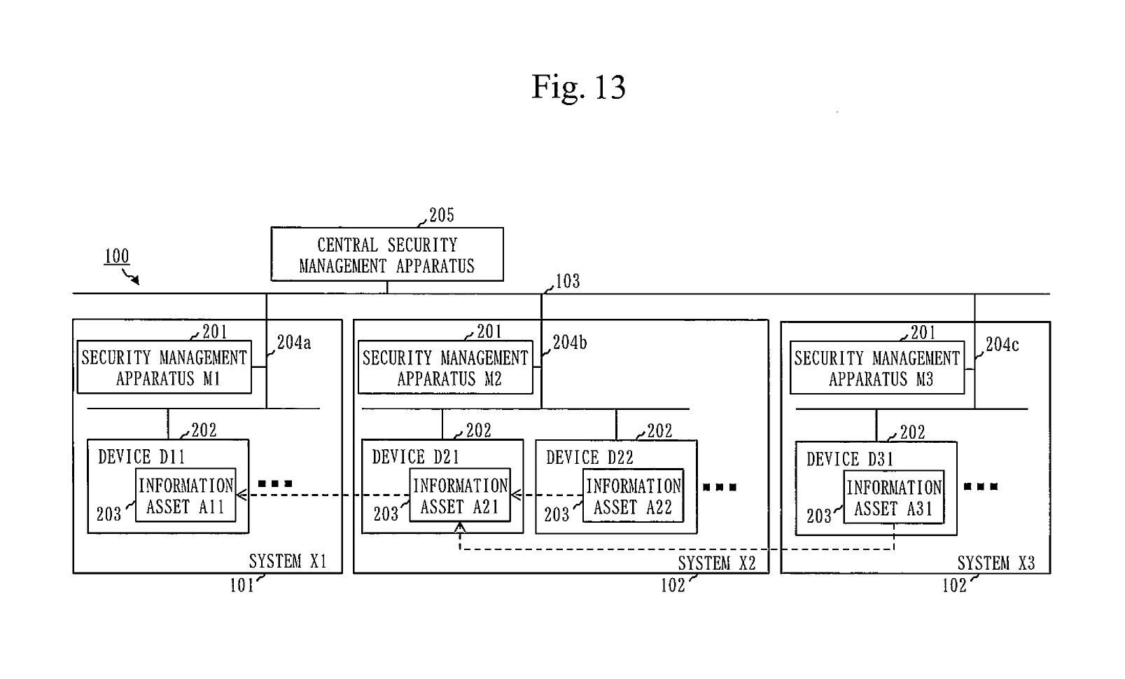

For the present embodiment, a difference from the first embodiment will be mainly described by using to FIGS. 13 to 27.

*** Description of Configuration ***

With reference to FIG. 13, a configuration of a SoS 100 according to the present embodiment will be described.

In the present embodiment, unlike the first embodiment, the SoS 100 includes a central security management apparatus 205 to supervise a security management apparatus 201.

The central security management apparatus 205 is connected to each system via the Internet 103.

In the present embodiment, as in the first embodiment, the security management apparatus 201 of a first system 101 obtains a dependence relation with other system corresponding to a second system 102 from a connection of an information asset 203, considers the dependence relation with other system, and selects and implements an optimum security measure so as not to cause an impact on other system. A difference from the first embodiment is that the security management apparatus 201 digitizes and compares an impact of a security measure on other system.

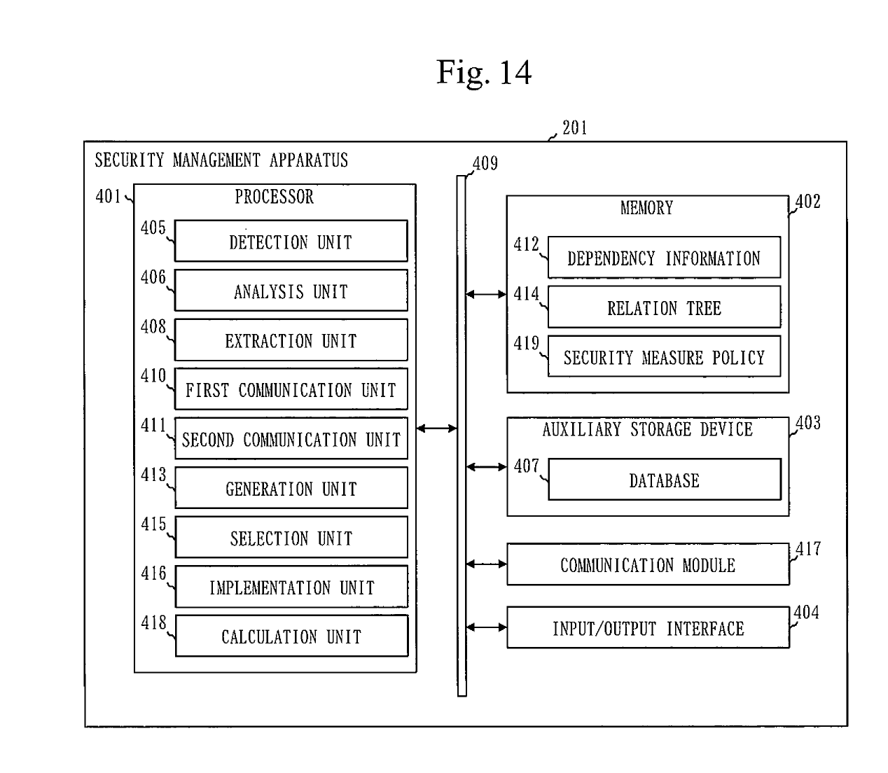

With reference to FIG. 14, a configuration of the security management apparatus 201 according to the present embodiment will be described.

The security management apparatus 201 includes, as functional elements, a calculation unit 418 in addition to a detection unit 405, an analysis unit 406, an extraction unit 408, a first communication unit 410, a second communication unit 411, a generation unit 413, a selection unit 415, and an implementation unit 416. A function of a “unit”, such as the detection unit 405, the analysis unit 406, the extraction unit 408, the first communication unit 410, the second communication unit 411, the generation unit 413, the selection unit 415, the implementation unit 416, or the calculation unit 418 is realized by software.

A memory 402 stores, in addition to dependency information 412 and a relation tree 414, a security measure policy 419 that is a definition of a condition to be satisfied by an index value for selecting a security measure.

Unlike the first embodiment, the second communication unit 411 is a functional element to communicate with the central security management apparatus 205 by using a communication module 417, and to provide a notification of entry to the SoS 101 and to share the dependency information 412 and the security measure policy 419 with the central security management apparatus 205. The security measure policy 419 received by the second communication unit 411 from the central security management apparatus 205 is stored and managed in the memory 402. The calculation unit 418 is a functional element to determine details of a security measure and calculate an impact degree caused by the security measure, from the security measure extracted by the extraction unit 408 and from the relation tree 414 stored in the memory 402. Unlike the first embodiment, the selection unit 415 is a functional element to select an optimum security measure based on the security measure policy 419 stored in the memory 402 and based on the impact degree calculated by the calculation unit 418.

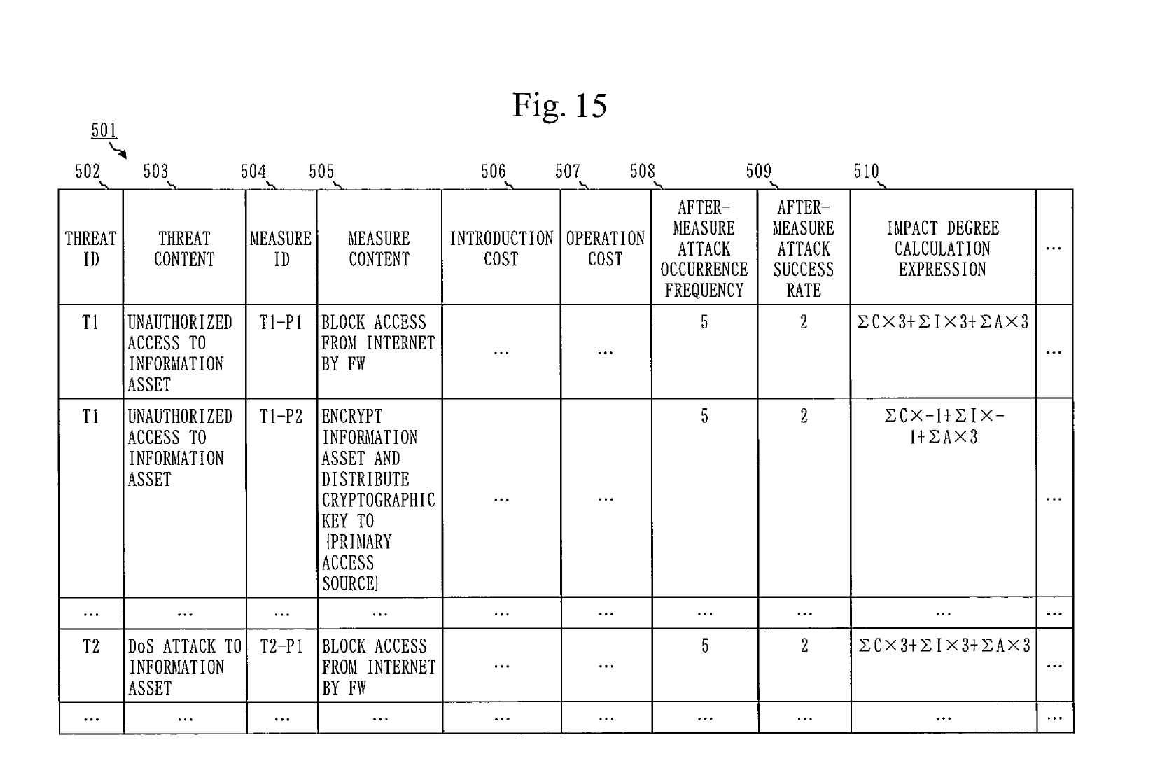

FIG. 15 illustrates an example of a security measure list 501 registered in a database 407. In this example, the security measure list 501 has a column of an impact degree calculation expression 510 in addition to the same columns as the example of FIG. 5. In the security measure list 501, a measure ID 504, an introduction cost 506, an operation cost 507, an after-measure attack occurrence frequency 508, an after-measure attack success rate 509, and the impact degree calculation expression 510 are defined for each measure content 505.

The impact degree calculation expression 510 is an arithmetic expression for calculating an impact degree of a security measure from an importance of the information asset 203 indicated in the relation tree 414 stored in the memory 402. In the present embodiment, the importance of the information asset 203 is set with three elements of confidentiality “C”, integrity “I”, and availability “A”. The impact degree calculation expression 510 is an expression for obtaining an impact degree of a security measure from the confidentiality “C”, the integrity “I”, and the availability “A”. It should be noted that, without limiting to the confidentiality “C”, the integrity “I”, and the availability “A”, the importance may be set with any elements.

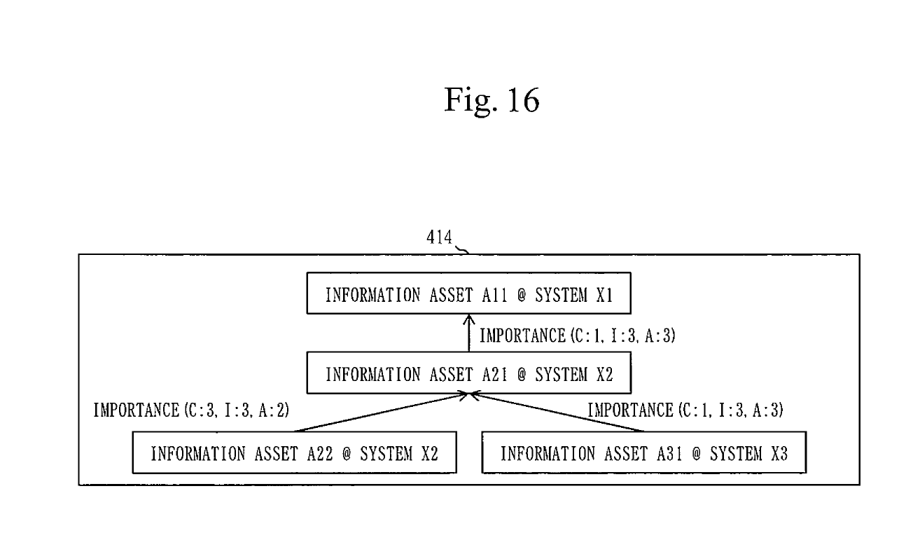

FIG. 16 illustrates an example of the relation tree 414 to be generated by the generation unit 413. In this example, the relation tree 414 indicates that an information asset A22 on a system X2 and an information asset A31 on a system X3 refer to an information asset A21 on the system X2, and that the information asset A21 on the system X2 refers to an information asset A11 on a system X1. Further, the relation tree 414 indicates that the information asset A22 refers to the information asset A21 with an importance “C: 3, I: 3, A: 2”, and the information asset A31 refers to the information asset A21 with an importance “C: 1, I: 3, A: 3”. In addition, the relation tree 414 indicates that the information asset A21 refers to the information asset A11 with an importance “C: 1, I: 3, A: 3”.

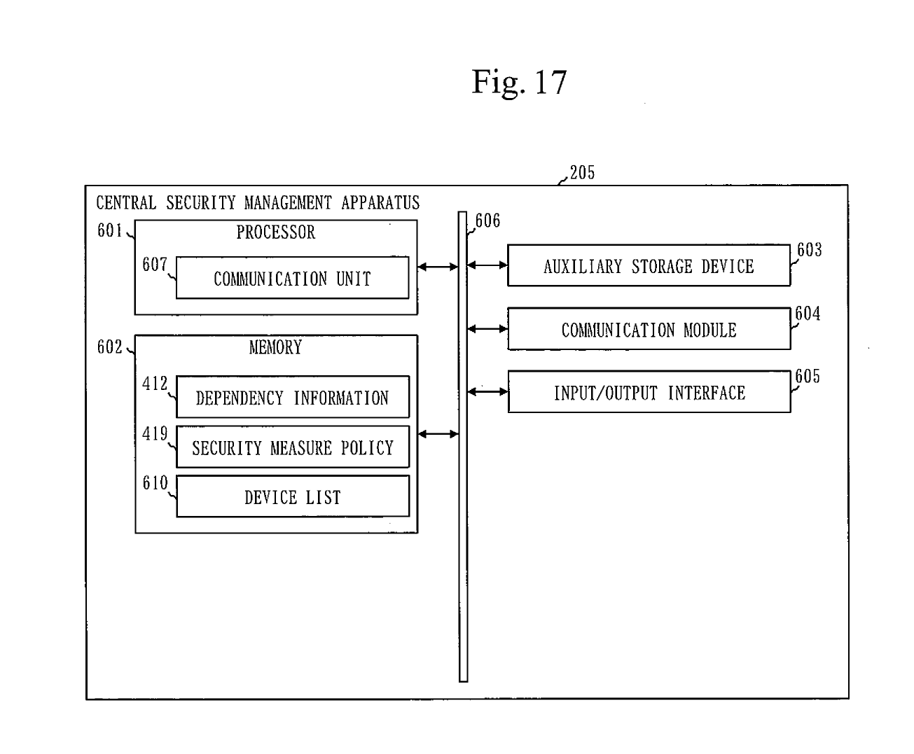

With reference to FIG. 17, a configuration of the central security management apparatus 205 according to the present embodiment will be described.

The central security management apparatus 205 is a computer. The central security management apparatus 205 includes a processor 601, and includes other hardware such as a memory 602, an auxiliary storage device 603, a communication module 604, and an input/output interface 605. The processor 601 is connected to other hardware via a bus 606, and controls this other hardware.

The central security management apparatus 205 includes, as a functional element, a communication unit 607 to communicate with the security management apparatus 201, and to receive a notification of entry to the SoS 101 or share the dependency information 412 and the security measure policy 419 with the security management apparatus 201. A function of the communication unit 607 is realized by software.

The processor 601 is an IC to perform processing. Specifically, the processor 601 is a CPU.

The memory 602 stores the dependency information 412 received by the communication unit 607 from the security management apparatus 201, the security measure policy 419 specified by an administrator who governs the entire SoS 101, and a device list 610 for management of the notification of entry received by the communication unit 607 from the security management apparatus 201. Specifically, the memory 602 is a flash memory or a RAM.

In the auxiliary storage device 603, a program for realizing the function of the communication unit 607 is stored. This program is loaded into the memory 602 and executed by the processor 601. The auxiliary storage device 603 also stores an OS. The processor 601 executes the program for realizing the function of the communication unit 607 while executing the OS. It should be noted that a part or the whole of the program for realizing the function of the communication unit 607 may be incorporated in the OS. Specifically, the auxiliary storage device 603 is an HDD or a flash memory.

The communication module 604 includes a receiver to receive data and a transmitter to transmit data. Specifically, the communication module 604 is a communication chip or an NIC.

The input/output interface 605 is a port connected with an input device or an output device that is not illustrated. Specifically, the input/output interface 605 is a USB terminal. Specifically, the input device is a mouse, a keyboard, or a touch panel. Specifically, the output device is an LCD.

The central security management apparatus 205 may include a plurality of processors substituting for the processor 601. These plurality of processors share execution of the program for realizing the function of the communication unit 607. Similarly to the processor 601, each processor is an IC to perform processing.

Information, data, a signal value, and a variable value that indicate a processing result of the communication unit 607 are stored in the memory 602, the auxiliary storage device 603, or a register or a cache memory in the processor 601.

The program for realizing the function of the communication unit 607 may be stored in a portable recording medium such as a magnetic disk or an optical disk.

It should be noted that the function of the communication unit 607 may be realized by a combination of software and hardware.

*** Description of Operation ***

With reference to FIGS. 8, and 18 to 27, an operation of the SoS 100 according to the present embodiment will be described. An operation of the security management apparatus 201 according to the present embodiment corresponds to a security management method according to the present embodiment. The operation of the security management apparatus 201 according to the present embodiment corresponds to a processing procedure of a security management program according to the present embodiment.

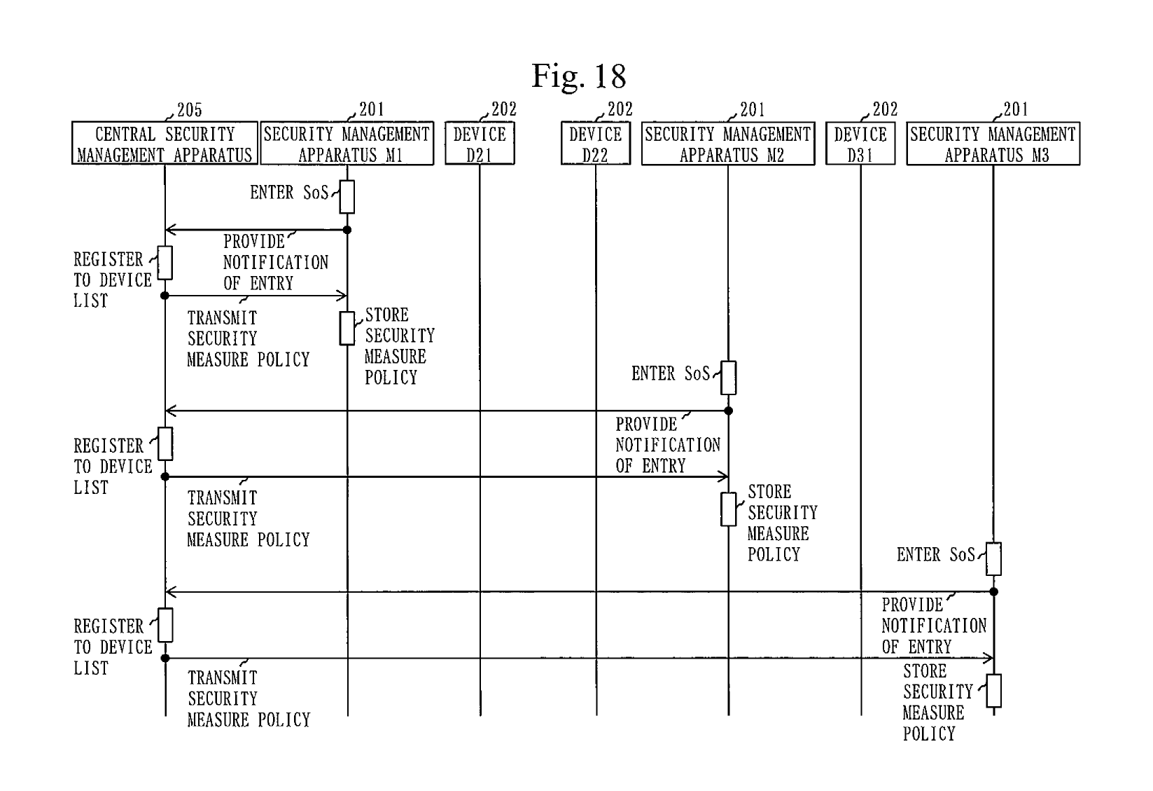

FIG. 18 illustrates that the system X1, the system X2, and the system X3 enter the SoS 101 in this order, but the order of entry is not limited to this. It is assumed that, in the memory 602 of the central security management apparatus 205, the security measure policy 419 specified by an administrator who governs the entire SoS 101 is stored in advance. The security measure policy 419 is “an information security measure with an impact degree of 30 or less” in this case, but may be “an information security measure with an impact degree of 30 or less and an after-measure attack success rate of 2 or less” and the like.

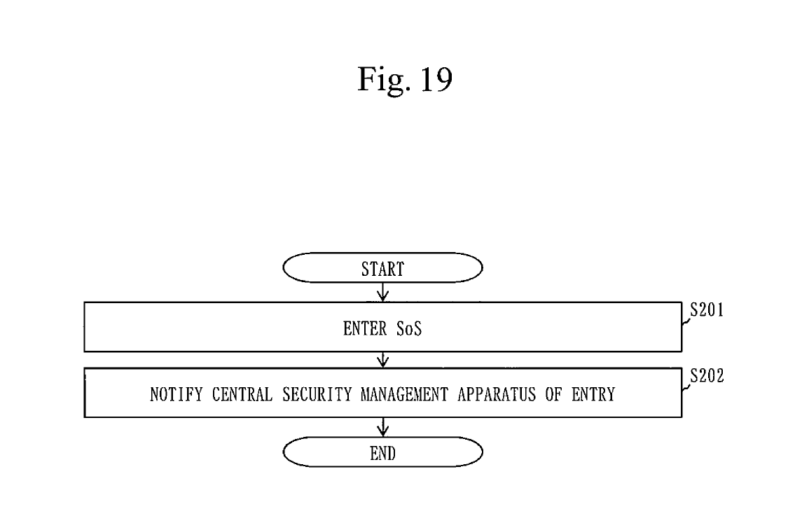

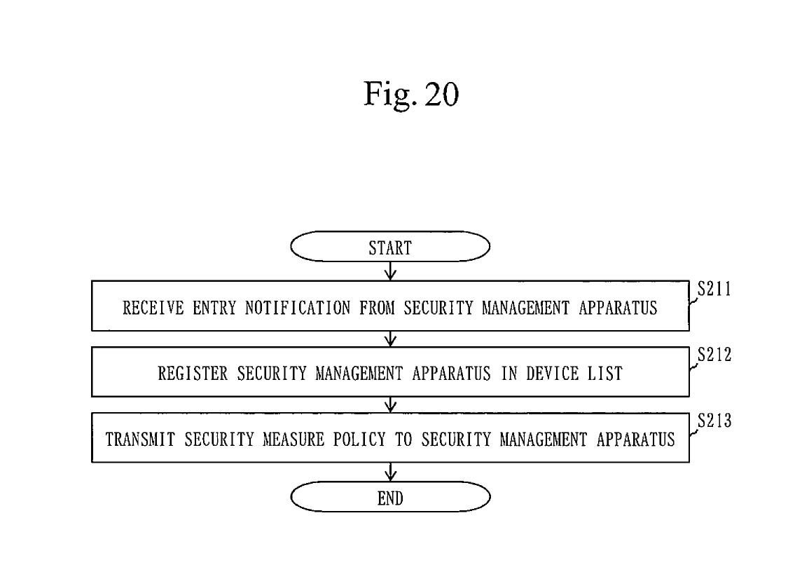

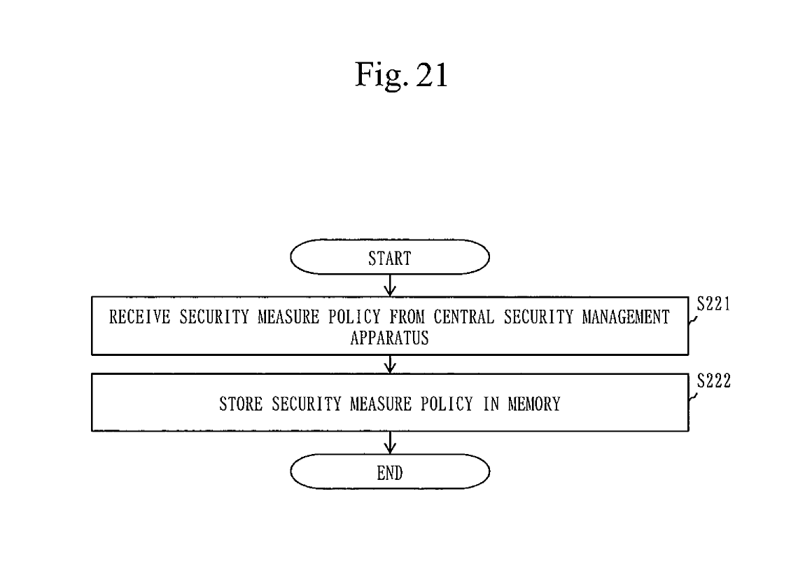

FIG. 19 illustrates an operation of the security management apparatus 201 at a time when each system enters the SoS 101. FIG. 20 illustrates an operation of the central security management apparatus 205 at a time when receiving an entry notification from the security management apparatus 201 of the system having entered the SoS 101. FIG. 21 illustrates an operation at a time when the security management apparatus 201 receives the security measure policy 419 from the central security management apparatus 205, after providing the entry notification to the central security management apparatus 205.

In step S201 of FIG. 19, when the system X1 enters the SoS 101, a second communication unit 411 of a security management apparatus M1 of the system X1 notifies the central security management apparatus 205 that it has entered the SoS 101, in step S202 of FIG. 19.

In step S211 of FIG. 20, the communication unit 607 of the central security management apparatus 205 receives an entry notification from the security management apparatus M1 of the system X1. In step S212 of FIG. 20, the central security management apparatus 205 registers, in the device list 610, that the system X1 has entered the SoS 101. In step S213 of FIG. 20, the communication unit 607 of the central security management apparatus 205 transmits the security measure policy 419 stored in the memory 602, to the security management apparatus M1 of the system X1.

In step S221 of FIG. 21, a second communication unit 411 of the security management apparatus M1 receives the security measure policy 419 from the central security management apparatus 205. In step S221 of FIG. 21, the security management apparatus M1 stores the received security measure policy 419 in a memory 402.

Similarly, when the system X2 enters the SoS 101 in step S201 of FIG. 19, a second communication unit 411 of a security management apparatus M2 of the system X2 notifies the central security management apparatus 205 that it has entered the SoS 101, in step S202 of FIG. 19.

In step S211 of FIG. 20, the communication unit 607 of the central security management apparatus 205 receives an entry notification from the security management apparatus M2 of the system X2. In step S212 of FIG. 20, the central security management apparatus 205 registers, in the device list 610, that the system X2 has entered the SoS 101. In step S213 of FIG. 20, the communication unit 607 of the central security management apparatus 205 transmits the security measure policy 419 stored in the memory 602, to the security management apparatus M2 of the system X2.

In step S221 of FIG. 21, a second communication unit 411 of the security management apparatus M2 receives the security measure policy 419 from the central security management apparatus 205. In step S221 of FIG. 21, the security management apparatus M2 stores the received security measure policy 419 in a memory 402.

Similarly, when the system X3 enters the SoS 101 in step S201 of FIG. 19, a second communication unit 411 of a security management apparatus M3 of the system X3 notifies the central security management apparatus 205 that it has entered the SoS 101, in step S202 of FIG. 19.

In step S211 of FIG. 20, the communication unit 607 of the central security management apparatus 205 receives an entry notification from the security management apparatus M3 of the system X3. In step S212 of FIG. 20, the central security management apparatus 205 registers, in the device list 610, that the system X3 has entered the SoS 101. In step S213 of FIG. 20, the communication unit 607 of the central security management apparatus 205 transmits the security measure policy 419 stored in the memory 602, to the security management apparatus M3 of the system X3.

In step S221 of FIG. 21, a second communication unit 411 of the security management apparatus M3 receives the security measure policy 419 from the central security management apparatus 205. In step S221 of FIG. 21, the security management apparatus M3 stores the received security measure policy 419 in a memory 402.

When an administrator who governs the entire SoS 101 changes the security measure policy 419, the communication unit 607 of the central security management apparatus 205 transmits the changed security measure policy 419 to the security management apparatus 201 that has entered the SoS 101. The security management apparatus 201 receives the security measure policy 419 from the central security management apparatus 205 and stores the security measure policy in the memory 402.

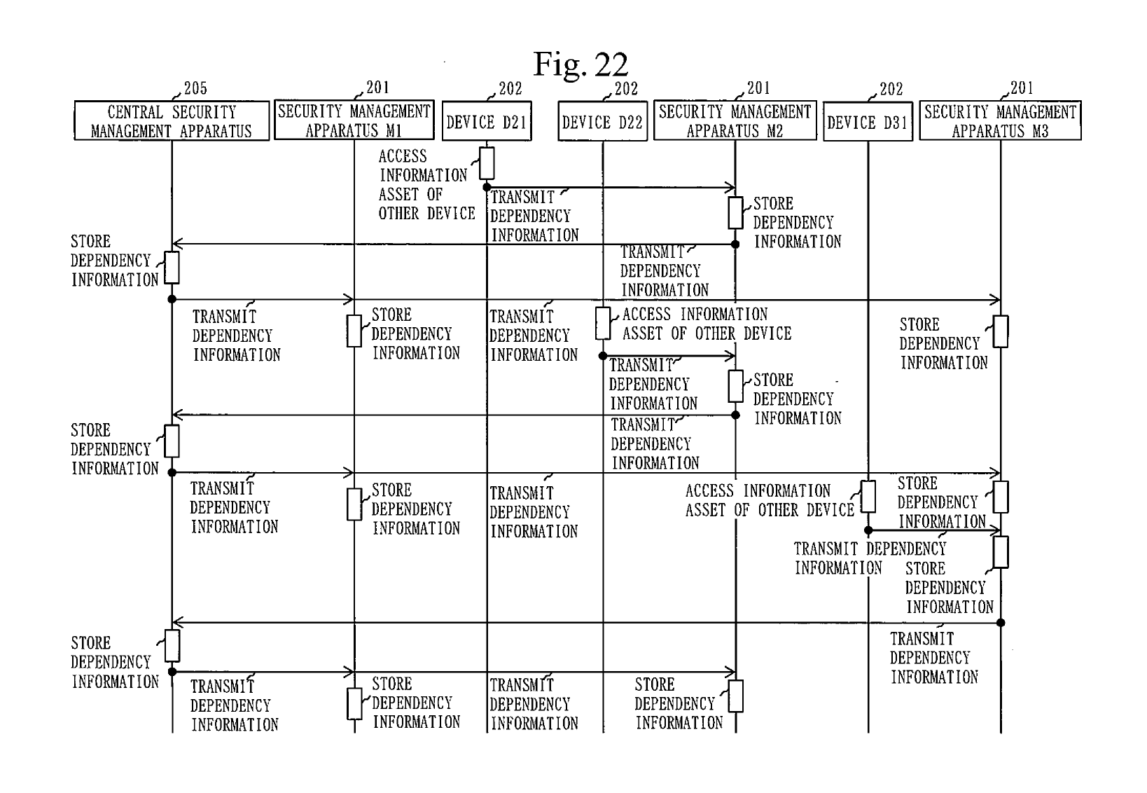

FIG. 22 illustrates that reference to the information asset 203 is made in the following order, but the order of reference is not limited to this. First, the information asset A21 on a device D21 of the system X2 refers to the information asset A11 on a device D11 of the system X1. Next, the information asset A22 on a device D22 of the system X2 refers to the information asset A21 on the device D21 of the system X2. Finally, the information asset A31 on a device D31 of the system X3 refers to the information asset A21 on the device D21 of the system X2.

Dependency information 412 transmitted and received between a device 202 and the security management apparatus 201 and between the security management apparatus 201 and the central security management apparatus 205 includes information asset information of a reference source, information asset information of a reference destination, and an importance of the information asset of the reference destination in the information asset of the reference source. In the present embodiment, the information asset information of the reference source and the information asset information of the reference destination that are included in the dependency information 412 are expressed with an information asset name and a system name in a form such as “information asset A11 @ system X1”, but any other expression may be used. As a specific example, the dependency information 412 may be formed of an information asset name, a host name, and a system name or a domain name. The dependency information 412 may be in any form as long as it can uniquely specify the information asset 203. Further, in the present embodiment, the importance included in the dependency information 412 is set with three elements of confidentiality “C”, integrity “I”, and availability “A”, but may be set with any other elements.

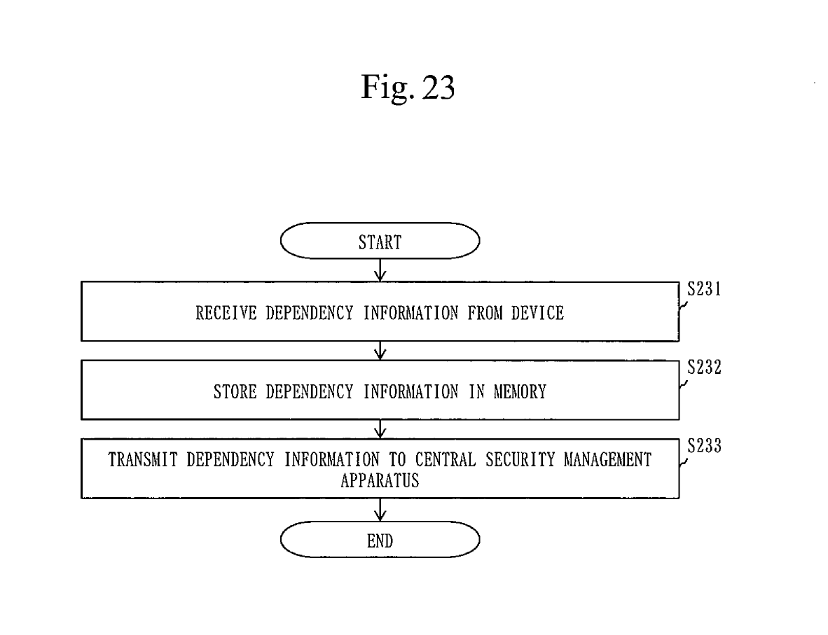

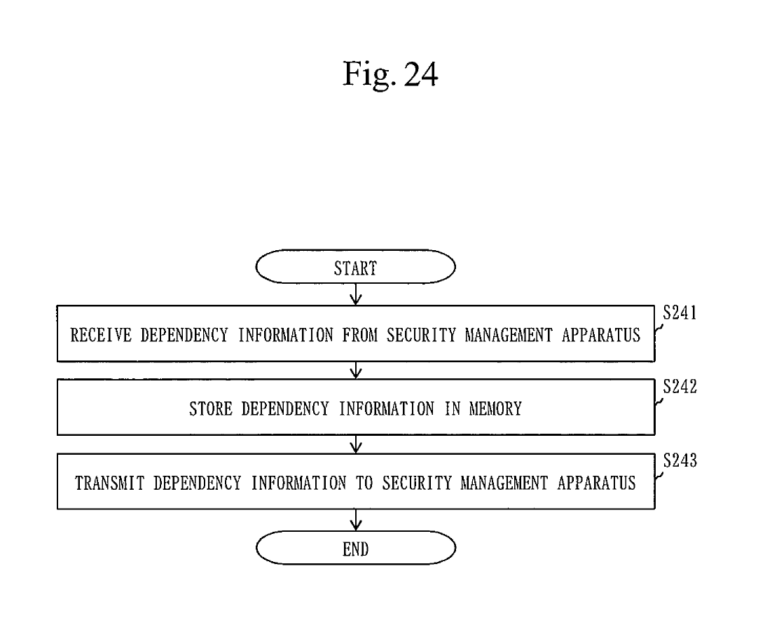

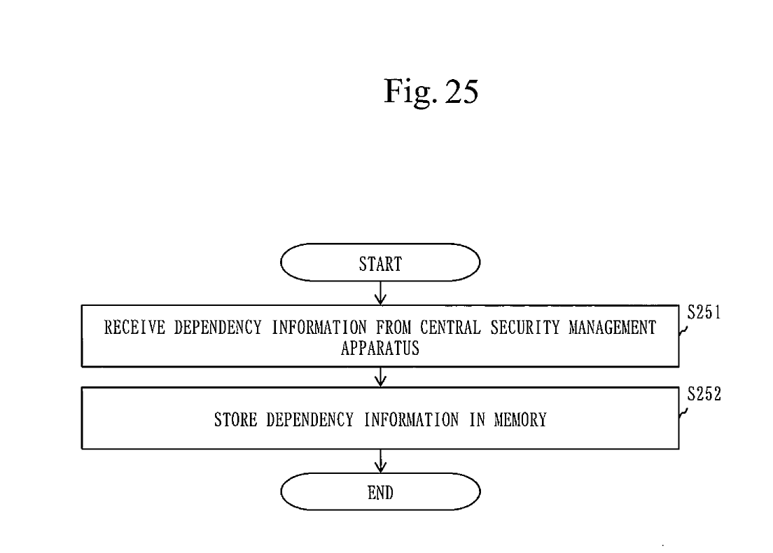

An operation of the device 202 is similar to that of the first embodiment illustrated in FIG. 8. FIG. 23 illustrates an operation at a time when the security management apparatus 201 receives the dependency information 412 from the device 202. FIG. 24 illustrates an operation at a time when the central security management apparatus 205 receives the dependency information 412 from the security management apparatus 201. FIG. 25 illustrates an operation at a time when the security management apparatus 201 receives the dependency information 412 from the central security management apparatus 205.

In step S101 of FIG. 8, in order to refer to the information asset A11 on the device D11 of the system X1, the information asset A21 on the device D21 of the system X2 accesses the information asset A11. In step S102 of FIG. 8, a communication unit 307 of the device D21 transmits dependency information 412 “information asset A21 @ system X2 to information asset A11 @ system X1” and “C: 1, I: 3, A: 3” to the security management apparatus M2 of the system X2.

In step S231 of FIG. 23, a first communication unit 410 of the security management apparatus M2 receives the dependency information 412 “information asset A21 @ system X2 to information asset A11 @ system X1” and “C: 1, I: 3, A: 3” from the device D21. In step S232 of FIG. 23, the security management apparatus M2 stores the received dependency information 412 “information asset A21 @ system X2 to information asset A11 @ system X1” and “C: 1, I: 3, A: 3” in the memory 402. In step S233 of FIG. 23, the second communication unit 411 of the security management apparatus M2 transmits the dependency information 412 “information asset A21 @ system X2 to information asset A11 @ system X1” and “C: 1, I: 3, A: 3” to the central security management apparatus 205.

In step S241 of FIG. 24, the communication unit 607 of the central security management apparatus 205 receives the dependency information 412 “information asset A21 @ system X2 to information asset A11 @ system X1” and “C: 1, I: 3, A: 3” from the security management apparatus M2 of the system X2. In step S242 of FIG. 24, the central security management apparatus 205 stores the dependency information 412 “information asset A21 @ system X2 to information asset A11 @ system X1” and “C: 1, I: 3, A: 3” in the memory 602. In step S243 of FIG. 24, the communication unit 607 of the central security management apparatus 205 transmits the dependency information 412 “information asset A21 @ system X2 to information asset A11 @ system X1” and “C: 1, I: 3, A: 3” to the security management apparatus M1 of the system X1 and the security management apparatus M3 of the system X3

In step S251 of FIG. 25, the second communication units 411 of the security management apparatus M1 of the system X1 and of the security management apparatus M3 of the system X3 receive the dependency information 412 “information asset A21 @ system X2 to information asset A11 @ system X1” and “C: 1, I: 3, A: 3” from the central security management apparatus 205. In step S252 of FIG. 25, the security management apparatuses M1 and M3 store the dependency information 412 “information asset A21 @ system X2 to information asset A11 @ system X1” and “C: 1, I: 3, A: 3” in the respective memories 402.

Similarly, in step S101 of FIG. 8, in order to refer to the information asset A21 on the device D21 of the system X2, the information asset A22 on the device D22 of the system X2 accesses the information asset A21. In step S102 of FIG. 8, a communication unit 307 of the device D22 transmits dependency information 412 “information asset A22 @ system X2 to information asset A21 @ system X2” and “C: 3, I: 3, A: 2” to the security management apparatus M2 of the system X2.

In step S231 of FIG. 23, the first communication unit 410 of the security management apparatus M2 receives the dependency information 412 “information asset A22 @ system X2 to information asset A21 @ system X2” and “C: 3, I: 3, A: 2” from the device D22. In step S232 of FIG. 23, the security management apparatus M2 stores the received dependency information 412 “information asset A22 @ system X2 to information asset A21 @ system X2” and “C: 3, I: 3, A: 2” in the memory 402. In step S233 of FIG. 23, the second communication unit 411 of the security management apparatus M2 transmits the dependency information 412 “information asset A22 @ system X2 to information asset A21 @ system X2” and “C: 3, I: 3, A: 2” to the central security management apparatus 205.

In step S241 of FIG. 24, the communication unit 607 of the central security management apparatus 205 receives the dependency information 412 “information asset A22 @ system X2 to information asset A21 @ system X2” and “C: 3, I: 3, A: 2” from the security management apparatus M2 of the system X2. In step S242 of FIG. 24, the central security management apparatus 205 stores the dependency information 412 “information asset A22 @ system X2 to information asset A21 @ system X2” and “C: 3, I: 3, A: 2” in the memory 602. In step S243 of FIG. 24, the communication unit 607 of the central security management apparatus 205 transmits the dependency information 412 “information asset A22 @ system X2 to information asset A21 @ system X2” and “C: 3, I: 3, A: 2” to the security management apparatus M1 of the system X1 and the security management apparatus M3 of the system X3.

In step S251 of FIG. 25, the second communication units 411 of the security management apparatus M1 of the system X1 and of the security management apparatus M3 of the system X3 receive the dependency information 412 “information asset A22 @ system X2 to information asset A21 @ system X2” and “C: 3, I: 3, A: 2” from the central security management apparatus 205. In step S252 of FIG. 25, the security management apparatuses M1 and M3 store the dependency information 412 “information asset A22 @ system X2 to information asset A21 @ system X2” and “C: 3, I: 3, A: 2” in the respective memories 402.

Similarly, in step S101 of FIG. 8, in order to refer to the information asset A21 on the device D21 of the system X2, the information asset A31 on the device D31 of the system X3 accesses the information asset A21. In step S102 of FIG. 8, a communication unit 307 of the device D31 transmits dependency information 412 “information asset A31 @ system X3 to information asset A21 @ system X2” and “C: 1, I: 3, A: 3” to the security management apparatus M3 of the system X3.

In step S231 of FIG. 23, a first communication unit 410 of the security management apparatus M3 receives the dependency information 412 “information asset A31 @ system X3 to information asset A21 @ system X2” and “C: 1, I: 3, A: 3” from the device D31. In step S232 of FIG. 23, the security management apparatus M3 stores the received dependency information 412 “information asset A31 @ system X3 to information asset A21 @ system X2” and “C: 1, I: 3, A: 3” in the memory 402. In step S233 of FIG. 23, the second communication unit 411 of the security management apparatus M3 transmits the dependency information 412 “information asset A31 @ system X3 to information asset A21 @ system X2” and “C: 1, I: 3, A: 3” to the central security management apparatus 205.

In step S241 of FIG. 24, the communication unit 607 of the central security management apparatus 205 receives the dependency information 412 “information asset A31 @ system X3 to information asset A21 @ system X2” and “C: 1, I: 3, A: 3” from the security management apparatus M3 of the system X3. In step S242 of FIG. 24, the central security management apparatus 205 stores the dependency information 412 “information asset A31 @ system X3 to information asset A21 @ system X2” and “C: 1, I: 3, A: 3” in the memory 602. In step S243 of FIG. 24, the communication unit 607 of the central security management apparatus 205 transmits the dependency information 412 “information asset A31 @ system X3 to information asset A21 @ system X2” and “C: 1, I: 3, A: 3” to the security management apparatus M1 of the system X1 and the security management apparatus M2 of the system X2.

In step S251 of FIG. 25, the second communication units 411 of the security management apparatus M1 of the system X1 and of the security management apparatus M2 of the system X2 receive the dependency information 412 “information asset A31 @ system X3 to information asset A21 @ system X2” and “C: 1, I: 3, A: 3” from the central security management apparatus 205. In step S252 of FIG. 25, the security management apparatuses M1 and M2 store the dependency information 412 “information asset A31 @ system X3 to information asset A21 @ system X2” and “C: 1, I: 3, A: 3” in the respective memories 402.

In the present embodiment, the dependency information 412 shared and stored among the security management apparatuses M1, M2, and M3 is the same and symmetrical in all the security management apparatuses 201. However, there is no need to transmit irrelevant dependency information 412 to an irrelevant security management apparatus 201, and the dependency information 412 shared and stored among the security management apparatuses M1, M2, and M3 may be different for each security management apparatus 201 and may be asymmetric.

As a specific example, in the present embodiment, since the dependency information 412 “information asset A21 @ system X2 to information asset A11 @ system X1” and “C: 1, I: 3, A: 3” transmitted from the security management apparatus M2 of the system X2 is unnecessary information for the security management apparatus M3 of the system X3, it does not need to be transmitted to the security management apparatus M3. That is, the central security management apparatus 205 only have to transmit the dependency information 412 “information asset A21 @ system X2 to information asset A11 @ system X1” and “C: 1, I: 3, A: 3” to the security management apparatus M1 of the system X1 only.

In addition, for an information asset 203 that is not referred to from an information asset 203 of other system and does not refer to an information asset 203 of other system, the security management apparatus 201 does not need to individually transmit the dependency information 412 to the central security management apparatus 205. Then, the security management apparatus 201 may add an importance of this information asset 203 to an importance of an information asset 203 referring to an information asset 203 of other system, and notify the central security management apparatus 205. Specifically, in the present embodiment, the information asset A22 on the device D22 of the system X2 is not referred to from an information asset 203 of other system, and does not refer to an information asset 203 of other system. Accordingly, the security management apparatus M2 adds the importance “C: 3, I: 3, A: 2” of the information asset A21 in the information asset A22 to the importance “C: 1, I: 3, A: 3” of the information asset A11 in the information asset A21, and notifies the central security management apparatus 205 of the importance of the information asset A11 in the information asset A21 as “C: 4, I: 6, A: 5”. Thereby, a dependence relation of the information assets 203 in the system is not to be known to other system. The same can be applied for an information asset 203 that is located between an information asset 203 referred to by an information asset 203 of other system and an information asset 203 referring to an information asset 203 of other system in the relation tree 414, and exists in the same system.

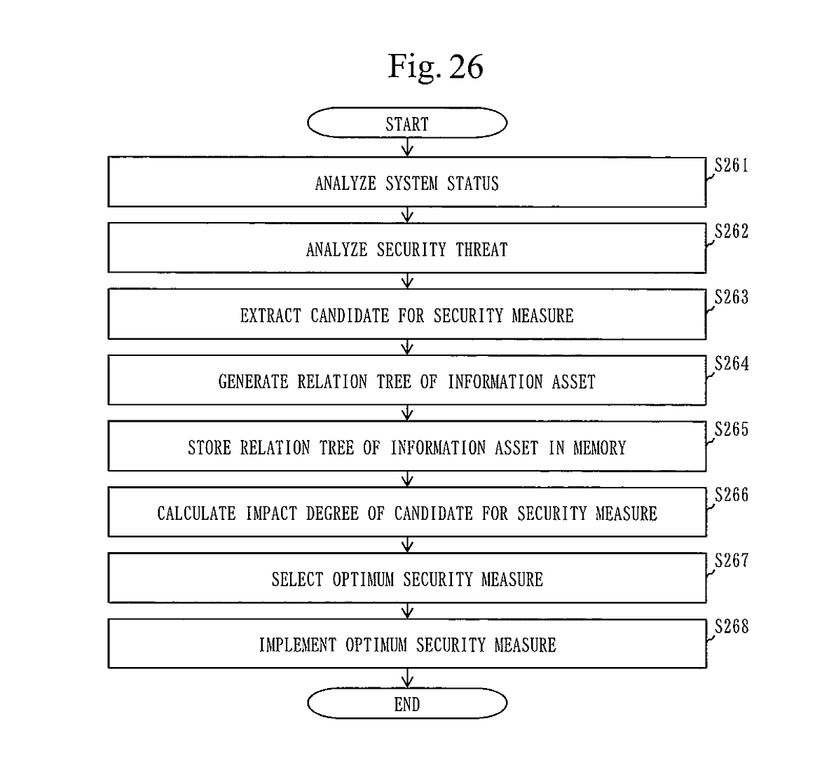

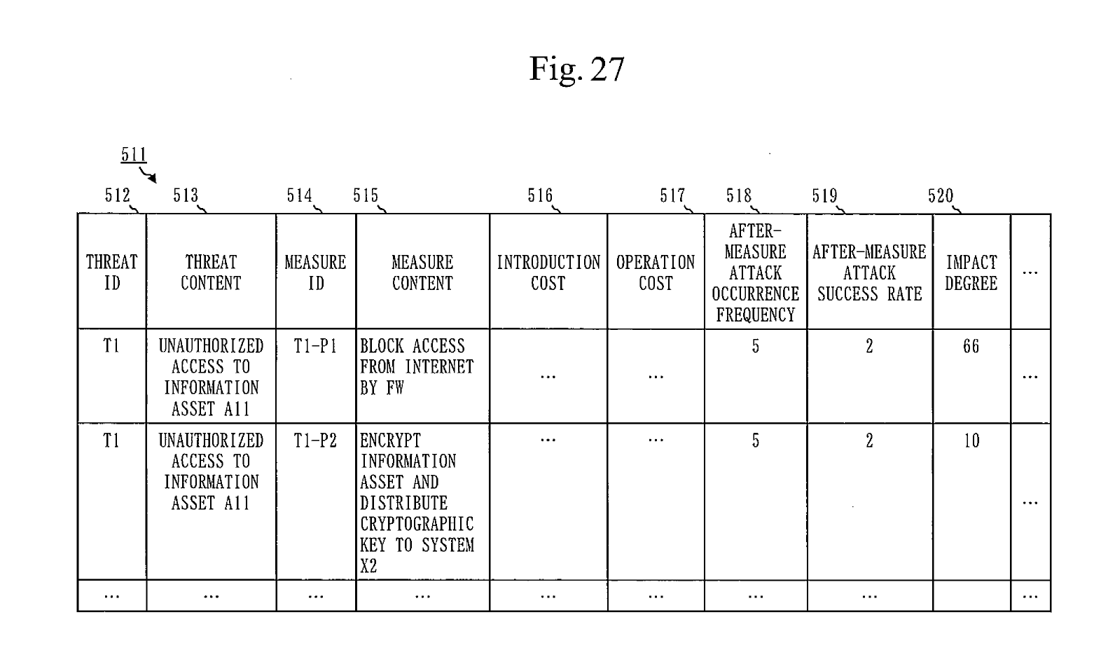

FIG. 26 illustrates an operation at a time when the security management apparatus 201 performs security threat analysis and implements a security measure. FIG. 27 is an example of a security measure evaluation table 511 for the calculation unit 418 of the security management apparatus 201 to evaluate a security measure extracted by the extraction unit 408, based on the relation tree 414 generated by the generation unit 413. In this example, the security measure evaluation table 511 has a column of an impact degree 520 in addition to the same columns as the example of FIG. 12.

Since processing from step S261 to step S263 in FIG. 26 is the same as processing from step S131 to step S133 in FIG. 11, the description will be omitted. Here again, it is assumed that the analysis unit 406 has found a threat of an unauthorized access to the information asset A11 on the device D11 of the system X1.

In step S264 of FIG. 26, a generation unit 413 of the security management apparatus M1 generates a relation tree 414 of the information asset 203 based on the dependency information 412 stored in the memory 402. In step S265 of FIG. 26, the generation unit 413 of the security management apparatus M1 stores the relation tree 414 in the memory 402. In step S266 of FIG. 26, a calculation unit 418 of the security management apparatus M1 sets an actual threat content 513 and an actual measure content 515 and calculates an impact degree 520 of a security measure, based on the candidates for a security measure extracted by the extraction unit 408 and based on the relation tree 414 stored in the memory 402. Then, the calculation unit 418 generates a security measure evaluation table 511 including the actual threat content 513, the actual measure content 515, and the impact degree 520 of a security measure. In step S267 of FIG. 26, a selection unit 415 of the security management apparatus M1 selects an optimum security measure from the security measure evaluation table 511 in accordance with the security measure policy 419 stored in the memory 402.

In step S268 of FIG. 26, an implementation unit 416 of the security management apparatus M1 implements the optimum security measure selected by the selection unit 415. It should be noted that, depending on an optimum security measure, the optimum security measure cannot be automatically implemented by the security management apparatus M1, and, are implemented by an administrator in that case.

*** Description of Effect of Embodiment ***

As described above, in the present embodiment, by obtaining a dependence relation with other system from a connection of the information assets 203, and obtaining, from the dependence relation with other system, an impact on other system caused by a security measure, it is possible to select and implement an optimum security measure considering an impact degree caused by the security measure. Therefore, it is possible to realize a safe security measure system in which a measure implemented in a certain system does not cause serious damage to other system.

In the present embodiment, the central security management apparatus 205 aggregates the dependency information 412 from the security management apparatus M1 corresponding to the security management apparatus 201 included in the first system 101, and from the security management apparatuses M2 and M3 corresponding to other security management apparatus 201 included in the one or more second systems 102. In step S251, the second communication unit 411 of the security management apparatus M1 receives, from the external central security management apparatus 205, dependency information 412 indicating a dependence relation among the information assets 203 individually held by the system X1 corresponding to the first system 101 and by the systems X2 and X3 corresponding to the second systems 102. This dependency information 412 includes information indicating an importance of the information asset A11 held by the system X1 with respect to the information asset A21 of a dependent source. In step S266, the calculation unit 418 of the security management apparatus M1 calculates, from the importance indicated by the dependency information 412, an impact degree 520 that is an evaluation value of a candidate for a security measure against a threat to the information asset A11. Then, in step S267, the selection unit 415 of the security management apparatus M1 selects a security measure to be implemented, from the candidates for a security measure against a threat to the information asset A11, in accordance with not only the dependence relation indicated by the dependency information 412 received by the second communication unit 411, but also the impact degree 520 calculated by the calculation unit 418.

As described above, in the present embodiment, from the candidates for a security measure for the information asset A11 held by the system X1, a security measure to be implemented is selected in accordance with the dependence relation among the information assets 203 individually held by the systems X1, X2, and X3, and with an impact degree on the systems X2 and X3 caused by the security measure. Therefore, as a security measure to be implemented in the system X1, it is possible to more reliably select a security measure that does not cause a large impact on the systems X2 and X3.

*** Other Configuration ***

In the present embodiment, as in the first embodiment, the function of the “unit” of the security management apparatus 201 is realized by software. However, as in the modification of the first embodiment, the function of the “unit” of the security management apparatus 201 may be realized by a combination of software and hardware.

### Third Embodiment

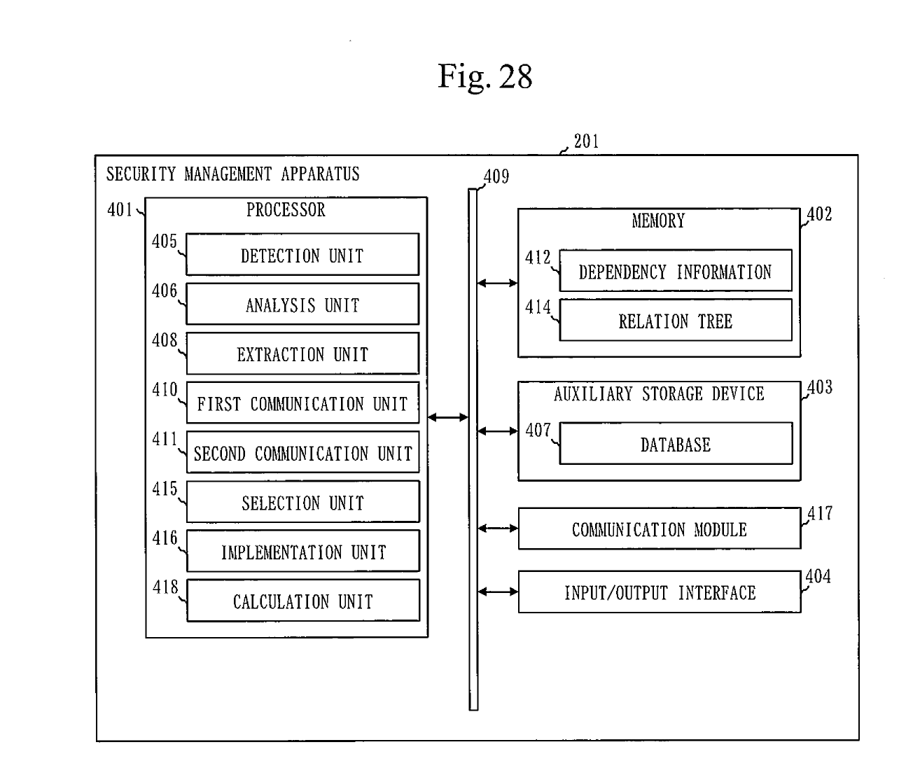

For the present embodiment, a difference from the second embodiment will be mainly described by using to FIGS. 28 to 40.

*** Description of Configuration ***

In the present embodiment, as in the second embodiment, a security management apparatus 201 of a first system 101 obtains a dependence relation with other system corresponding to a second system 102 from a connection of an information asset 203, considers the dependence relation with other system, and selects and implements an optimum security measure so as not to cause an impact on other system. A difference from the second embodiment is that the security management apparatus 201 inquires of a central security management apparatus 205 about a dependence relation with other system and about a candidate for a security measure to be implemented.

With reference to FIG. 28, a configuration of the security management apparatus 201 according to the present embodiment will be described.

The security management apparatus 201 includes, as functional elements, a detection unit 405, an analysis unit 406, an extraction unit 408, a first communication unit 410, a second communication unit 411, a selection unit 415, an implementation unit 416, and a calculation unit 418, but does not include a generation unit 413 unlike the second embodiment. A function of a “unit”, such as the detection unit 405, the analysis unit 406, the extraction unit 408, the first communication unit 410, the second communication unit 411, the selection unit 415, the implementation unit 416, or the calculation unit 418 is realized by software.

The second communication unit 411 is a functional element to communicate with the central security management apparatus 205 by using a communication module 417, and to share dependency information 412 with the central security management apparatus 205, to provide a notification of a system status such as a network configuration grasped by the detection unit 405, and to inquire about a relation tree 414 of an information asset 203 and about security measures to be implemented. The calculation unit 418 is a functional element to determine details of a security measure and calculate an impact degree caused by the security measure, from the relation tree 414 obtained from the central security management apparatus 205 and the security measure extracted by the extraction unit 408. The selection unit 415 is a functional element to select, from a response of security measures to be implemented inquired to the central security management apparatus 205, an optimum security measure based on a security measure policy specified by an administrator and based on the impact degree calculated by the calculation unit 418.

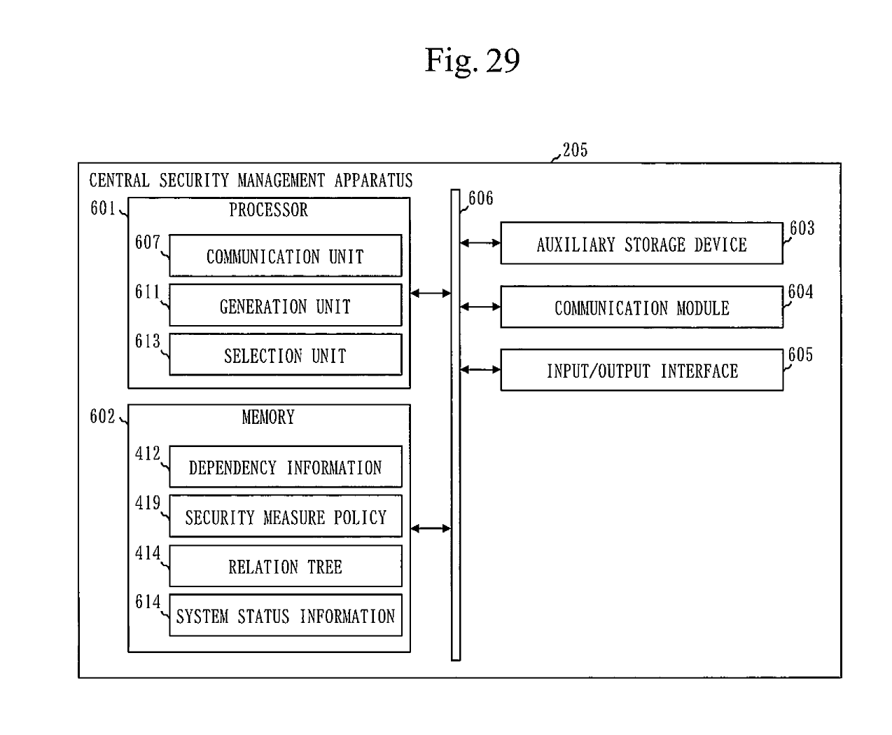

With reference to FIG. 29, a configuration of the central security management apparatus 205 according to the present embodiment will be described.

In addition to a communication unit 607, the central security management apparatus 205 includes a generation unit 611 and a selection unit 613 as functional elements. A function of a “unit” such as the communication unit 607, the generation unit 611, or the selection unit 613 is realized by software.

The memory 602 stores, in addition to the dependency information 412 and a security measure policy 419, the relation tree 414 that is tree-structured data representing a connection of the information assets 203, and system status information 614 received by the communication unit 607 from the security management apparatus 201.

The communication unit 607 is a functional element to communicate with the security management apparatus 201 by using the communication module 604, and to share the dependency information 412 with the security management apparatus 201, receive the system status information 614, and respond to inquiries about the relation tree 414 and security measure to be implemented. The dependency information 412 and the system status information 614 received by the communication unit 607 are stored and managed in the memory 602. The generation unit 611 is a functional element to generate a relation tree 414 of the information asset 203 based on the dependency information 412 stored in the memory 602. The relation tree 414 generated by the generation unit 611 is stored and managed in the memory 602. The selection unit 613 is a functional element to select a security measure to be implemented based on the relation tree 414, the system status information 614, and the security measure policy 419 that are stored in the memory 602, in response to an inquiry from the security management apparatus 201 about a security measure to be implemented.

It should be noted that the function of the “unit” of the central security management apparatus 205 may be realized by a combination of software and hardware.

*** Description of Operation ***

With reference to FIGS. 8, 23, and 30 to 40, an operation of a SoS 100 according to the present embodiment will be described. An operation of the central security management apparatus 205 according to the present embodiment corresponds to a security management method according to the present embodiment. The operation of the central security management apparatus 205 according to the present embodiment corresponds to a processing procedure of a security management program according to the present embodiment.

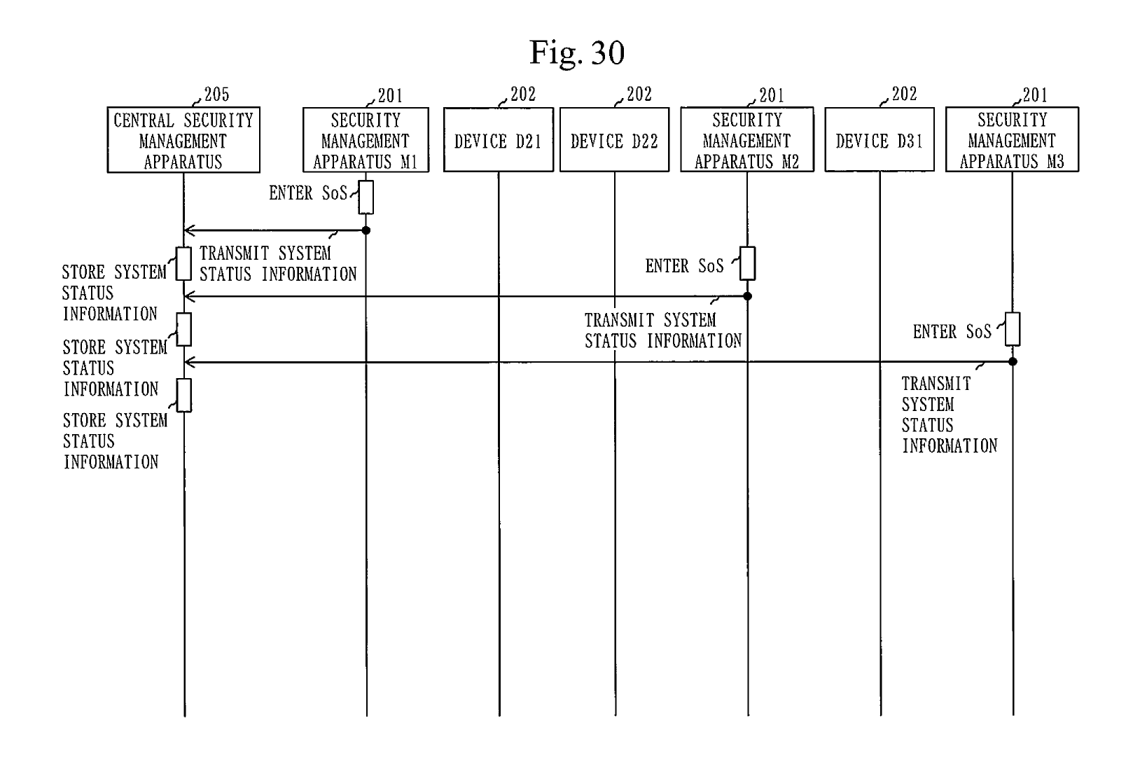

FIG. 30 illustrates that a system X1, a system X2, and a system X3 enter the SoS 101 in this order, but the order of entry is not limited to this. It is assumed that, in the memory 602 of the central security management apparatus 205, the security measure policy 419 specified by an administrator who governs the entire SoS 101 is stored in advance. The security measure policy 419 is “an information security measure with an impact degree of 30 or less” in this case, but may be “an information security measure with an impact degree of 30 or less and an after-measure attack success rate of 2 or less” and the like.

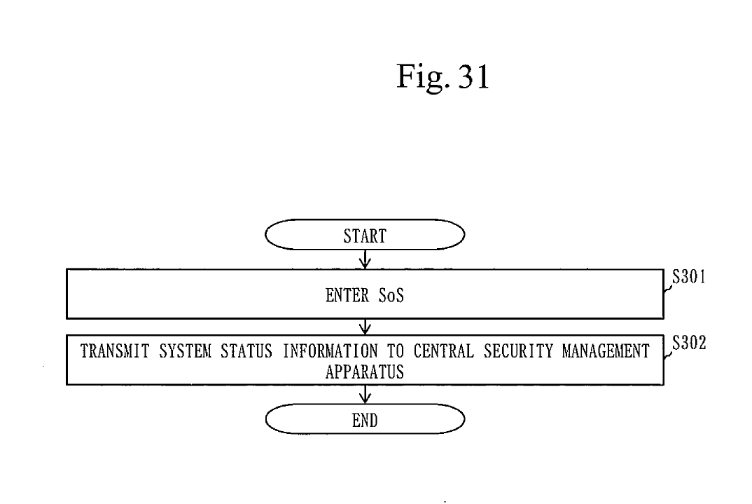

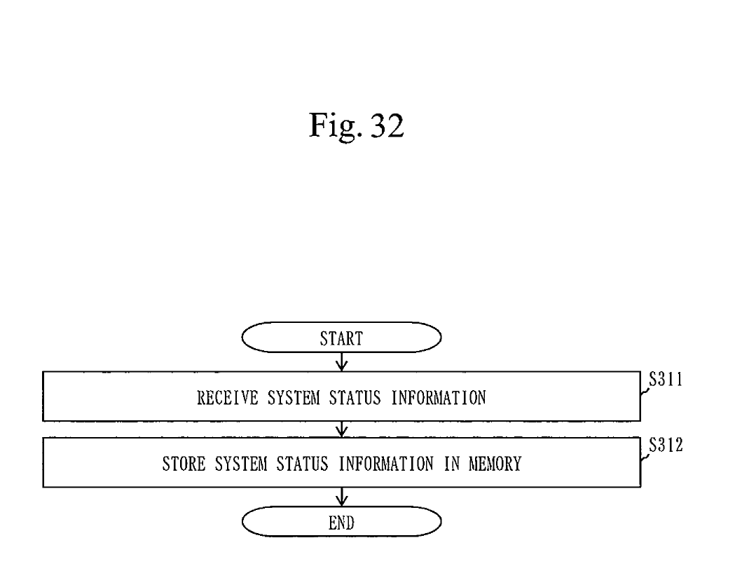

FIG. 31 illustrates an operation of the security management apparatus 201 at a time when each system enters the SoS 101. FIG. 32 illustrates an operation at a time when the central security management apparatus 205 receives the system status information 614 from the security management apparatus 201.

In step S301 of FIG. 31, when the system X1 enters the SoS 101, a detection unit 405 of a security management apparatus M1 of the system X1 collects, as the system status information 614, information on a status of the system X1 such as a network configuration, a system configuration, and a holding status of an information asset 203. In step S302 of FIG. 31, a second communication unit 411 of the security management apparatus M1 of the system X1 transmits the system status information 614 to the central security management apparatus 205.

In step S311 of FIG. 32, the communication unit 607 of the central security management apparatus 205 receives the system status information 614 from the security management apparatus M1 of the system X1. In step S312 of FIG. 32, the central security management apparatus 205 stores the received system status information 614 in the memory 602.

Similarly, when the system X2 enters the SoS 101 in step S301 of FIG. 31, a detection unit 405 of a security management apparatus M2 of the system X2 collects, as the system status information 614, information on a status of the system X2 such as a network configuration, a system configuration, and a holding status of an information asset 203. In step S302 of FIG. 31, a second communication unit 411 of the security management apparatus M2 of the system X2 transmits the system status information 614 to the central security management apparatus 205.

In step S311 of FIG. 32, the communication unit 607 of the central security management apparatus 205 receives the system status information 614 from the security management apparatus M2 of the system X2. In step S312 of FIG. 32, the central security management apparatus 205 stores the received system status information 614 in the memory 602.

Similarly, when the system X3 enters the SoS 101 in step S301 of FIG. 31, a detection unit 405 of a security management apparatus M3 of the system X3 collects, as the system status information 614, information on a status of the system X3 such as a network configuration, a system configuration, and a holding status of an information asset 203. In step S302 of FIG. 31, a second communication unit 411 of the security management apparatus M3 of the system X3 transmits the system status information 614 to the central security management apparatus 205.

In step S311 of FIG. 32, the communication unit 607 of the central security management apparatus 205 receives the system status information 614 from the security management apparatus M3 of the system X3. In step S312 of FIG. 32, the central security management apparatus 205 stores the received system status information 614 in the memory 602.

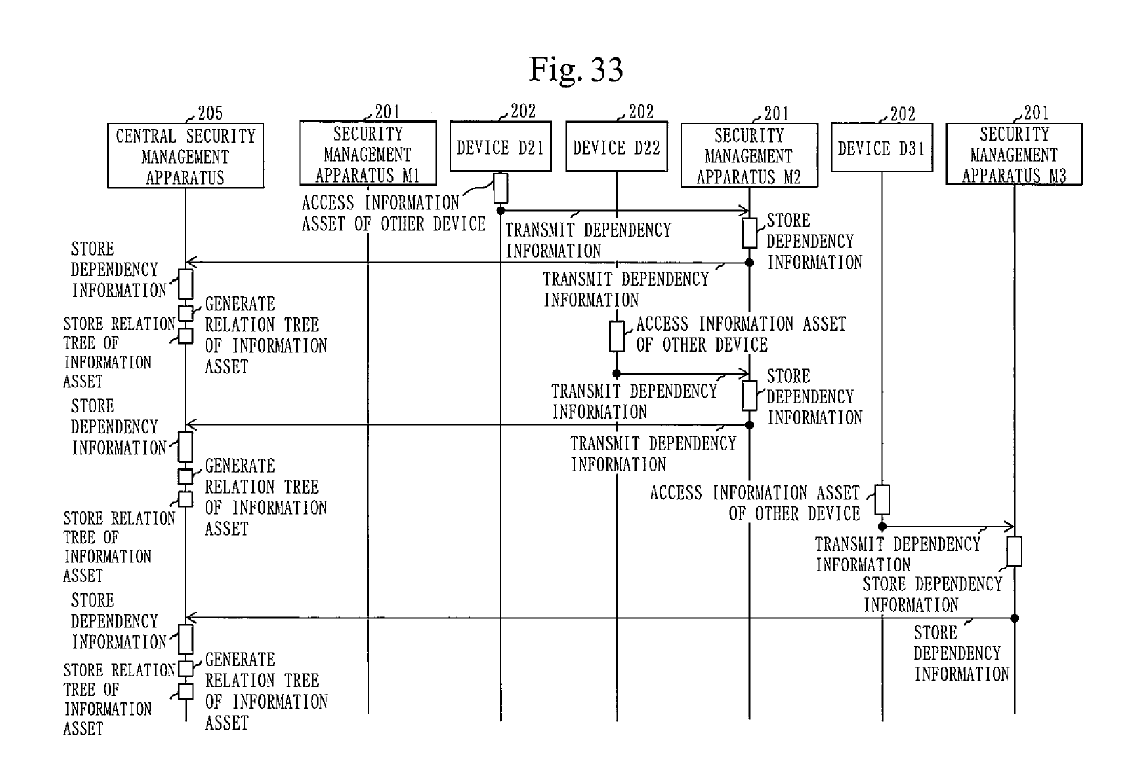

FIG. 33 illustrates that reference to the information asset 203 is made in the following order, but the order of reference is not limited to this. First, an information asset A21 on a device D21 of the system X2 refers to an information asset A11 on a device D11 of the system X1. Next, an information asset A22 on a device D22 of the system X2 refers to the information asset A21 on the device D21 of the system X2. Finally, an information asset A31 on a device D31 of the system X3 refers to the information asset A21 on the device D21 of the system X2.

Dependency information 412 transmitted and received between a device 202 and the security management apparatus 201 and between the security management apparatus 201 and the central security management apparatus 205 includes, similarly to that in the second embodiment, information asset information of a reference source, information asset information of a reference destination, and an importance of the information asset of the reference destination in the information asset of the reference source.

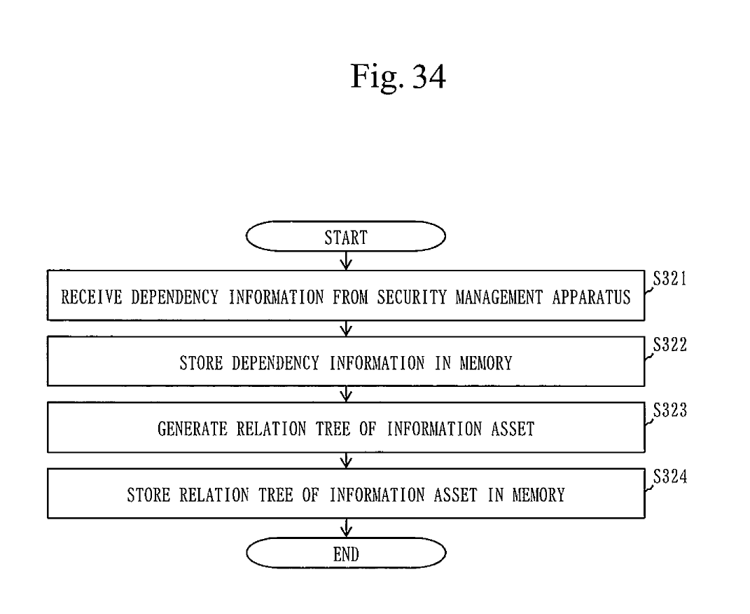

An operation of the device 202 is similar to that of the first embodiment illustrated in FIG. 8. An operation at a time when the security management apparatus 201 receives the dependency information 412 from the device 202 is similar to that of the second embodiment illustrated in FIG. 23. FIG. 34 illustrates an operation at a time when the central security management apparatus 205 receives the dependency information 412 from the security management apparatus 201.

In step S101 of FIG. 8, in order to refer to the information asset A11 on the device D11 of the system X1, the information asset A21 on the device D21 of the system X2 accesses the information asset A11. In step S102 of FIG. 8, a communication unit 307 of the device D21 transmits dependency information 412 “information asset A21 @ system X2 to information asset A11 @ system X1” and “C: 1, I: 3, A: 3” to the security management apparatus M2 of the system X2.

In step S231 of FIG. 23, a first communication unit 410 of the security management apparatus M2 receives the dependency information 412 “information asset A21 @ system X2 to information asset A11 @ system X1” and “C: 1, I: 3, A: 3” from the device D21. In step S232 of FIG. 23, the security management apparatus M2 stores the received dependency information 412 “information asset A21 @ system X2 to information asset A11 @ system X1” and “C: 1, I: 3, A: 3” in a memory 402. In step S233 of FIG. 23, the second communication unit 411 of the security management apparatus M2 transmits the dependency information 412 “information asset A21 @ system X2 to information asset A11 @ system X1” and “C: 1, I: 3, A: 3” to the central security management apparatus 205.

In step S321 of FIG. 34, the communication unit 607 of the central security management apparatus 205 receives the dependency information 412 “information asset A21 @ system X2 to information asset A11 @ system X1” and “C: 1, I: 3, A: 3” from the security management apparatus M2 of the system X2. In step S322 of FIG. 34, the central security management apparatus 205 stores the dependency information 412 “information asset A21 @ system X2 to information asset A11 @ system X1” and “C: 1, I: 3, A: 3” in the memory 602. In step S323 of FIG. 34, the generation unit 611 of the central security management apparatus 205 generates a relation tree 414 of the information asset 203 based on the dependency information 412 “information asset A21 @ system X2 to information asset A11 @ system X1” and “C: 1, I: 3, A: 3” stored in the memory 602. In step S324 of FIG. 34, the generation unit 611 of the central security management apparatus 205 stores the relation tree 414 in the memory 602.

Similarly, in step S101 of FIG. 8, in order to refer to the information asset A21 on the device D21 of the system X2, the information asset A22 on the device D22 of the system X2 accesses the information asset A21. In step S102 of FIG. 8, a communication unit 307 of the device D22 transmits dependency information 412 “information asset A22 @ system X2 to information asset A21 @ system X2” and “C: 3, I: 3, A: 2” to the security management apparatus M2 of the system X2.

In step S231 of FIG. 23, the first communication unit 410 of the security management apparatus M2 receives the dependency information 412 “information asset A22 @ system X2 to information asset A21 @ system X2” and “C: 3, I: 3, A: 2” from the device D22. In step S232 of FIG. 23, the security management apparatus M2 stores the received dependency information 412 “information asset A22 @ system X2 to information asset A21 @ system X2” and “C: 3, I: 3, A: 2” in the memory 402. In step S233 of FIG. 23, the second communication unit 411 of the security management apparatus M2 transmits the dependency information 412 “information asset A22 @ system X2 to information asset A21 @ system X2” and “C: 3, I: 3, A: 2” to the central security management apparatus 205.

In step S321 of FIG. 34, the communication unit 607 of the central security management apparatus 205 receives the dependency information 412 “information asset A22 @ system X2 to information asset A21 @ system X2” and “C: 3, I: 3, A: 2” from the security management apparatus M2 of the system X2. In step S322 of FIG. 34, the central security management apparatus 205 stores the dependency information 412 “information asset A22 @ system X2 to information asset A21 @ system X2” and “C: 3, I: 3, A: 2” in the memory 602. In step S323 of FIG. 34, the generation unit 611 of the central security management apparatus 205 generates a relation tree 414 of the information asset 203 based on the dependency information 412 “information asset A22 @ system X2 to information asset A21 @ system X2” and “C: 3, I: 3, A: 2” stored in the memory 602. In step S324 of FIG. 34, the generation unit 611 of the central security management apparatus 205 stores the relation tree 414 in the memory 602.

Similarly, in step S101 of FIG. 8, in order to refer to the information asset A21 on the device D21 of the system X2, the information asset A31 on the device D31 of the system X3 accesses the information asset A21. In step S102 of FIG. 8, a communication unit 307 of the device D31 transmits dependency information 412 “information asset A31 @ system X3 to information asset A21 @ system X2” and “C: 1, I: 3, A: 3” to the security management apparatus M3 of the system X3.

In step S231 of FIG. 23, a first communication unit 410 of the security management apparatus M3 receives the dependency information 412 “information asset A31 @ system X3 to information asset A21 @ system X2” and “C: 1, I: 3, A: 3” from the device D31. In step S232 of FIG. 23, the security management apparatus M3 stores the received dependency information 412 “information asset A31 @ system X3 to information asset A21 @ system X2” and “C: 1, I: 3, A: 3” in a memory 402. In step S233 of FIG. 23, the second communication unit 411 of the security management apparatus M3 transmits the dependency information 412 “information asset A31 @ system X3 to information asset A21 @ system X2” and “C: 1, I: 3, A: 3” to the central security management apparatus 205.

In step S321 of FIG. 34, the communication unit 607 of the central security management apparatus 205 receives the dependency information 412 “information asset A31 @ system X3 to information asset A21 @ system X2” and “C: 1, I: 3, A: 3” from the security management apparatus M3 of the system X3. In step S322 of FIG. 34, the central security management apparatus 205 stores the dependency information 412 “information asset A31 @ system X3 to information asset A21 @ system X2” and “C: 1, I: 3, A: 3” in the memory 602. In step S323 of FIG. 34, the generation unit 611 of the central security management apparatus 205 generates a relation tree 414 of the information asset 203 based on the dependency information 412 “information asset A31 @ system X3 to information asset A21 @ system X2” and “C: 1, I: 3, A: 3” stored in the memory 602. In step S324 of FIG. 34, the generation unit 611 of the central security management apparatus 205 stores the relation tree 414 in the memory 602.

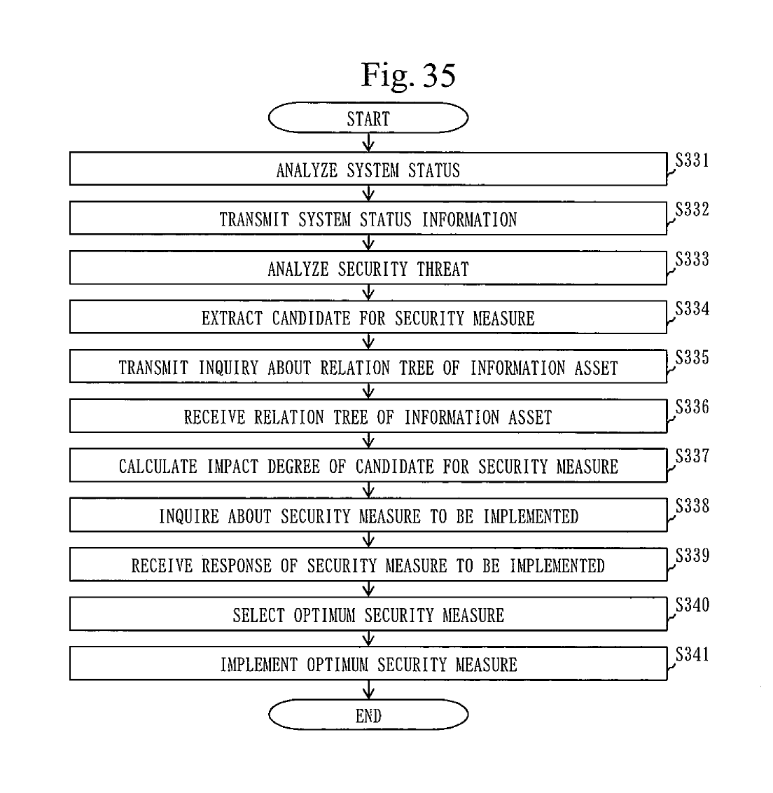

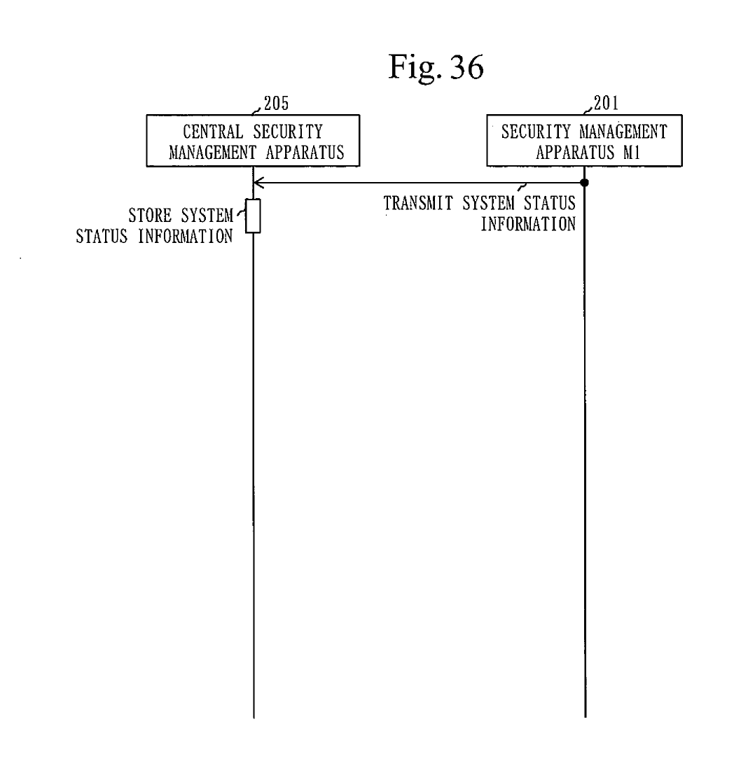

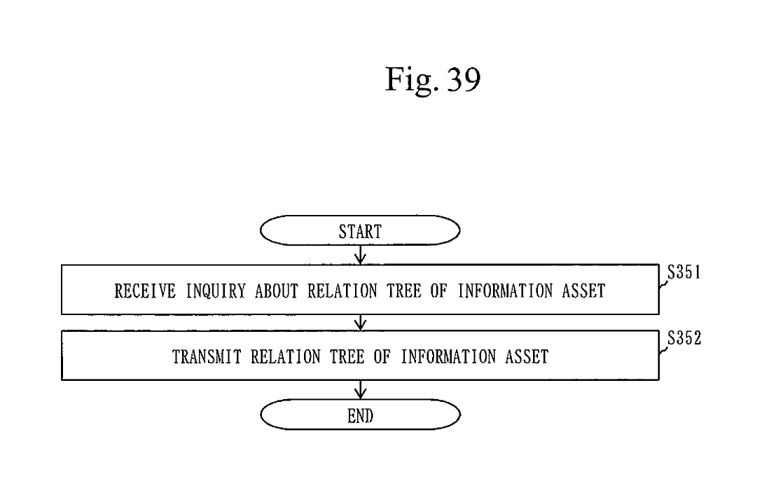

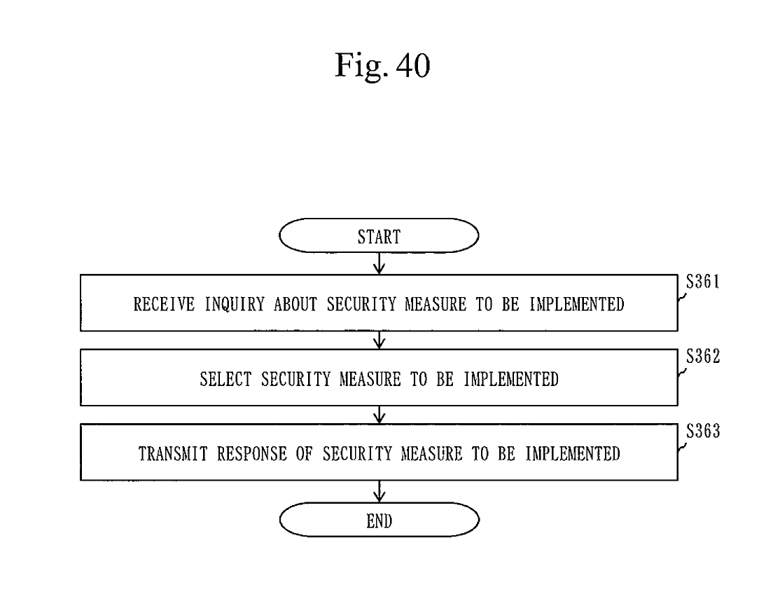

FIG. 35 illustrates an operation at a time when the security management apparatus 201 performs security threat analysis and implements a security measure. During this operation, communications as illustrated in FIGS. 36, 37, and 38 are performed between the security management apparatus 201 and the central security management apparatus 205. FIG. 39 illustrates an operation at a time when the central security management apparatus 205 receives an inquiry from the security management apparatus 201 about the relation tree 414. FIG. 40 illustrates an operation at a time when the central security management apparatus 205 receives an inquiry from the security management apparatus 201 about a security measure to be implemented.

In step S331 of FIG. 35, the detection unit 405 of the security management apparatus M1 collects, as the system status information 614, information on a status of the system X1 such as a network configuration, a system configuration, and a holding status of an information asset 203, and analyzes a system status based on the system status information 614. When there is a change in the system status, the second communication unit 411 of the security management apparatus M1 transmits the system status information 614 to the central security management apparatus 205 in step S332 of FIG. 35. According to a communication procedure illustrated in FIG. 36, the communication unit 607 of the central security management apparatus 205 receives the system status information 614 from the security management apparatus M1 and stores the system status information in the memory 602.

In step S333 of FIG. 35, an analysis unit 406 of the security management apparatus M1 performs security threat analysis based on the system status information 614. In step S334 of FIG. 35, an extraction unit 408 of the security management apparatus M1 extracts all candidates for a security measure that can be taken from a security measure list 501 registered in a database 407, based on the threat identified by the analysis unit 406. Here, it is assumed that the analysis unit 406 has found a threat of an unauthorized access to the information asset A11 on the device D11 of the system X1.

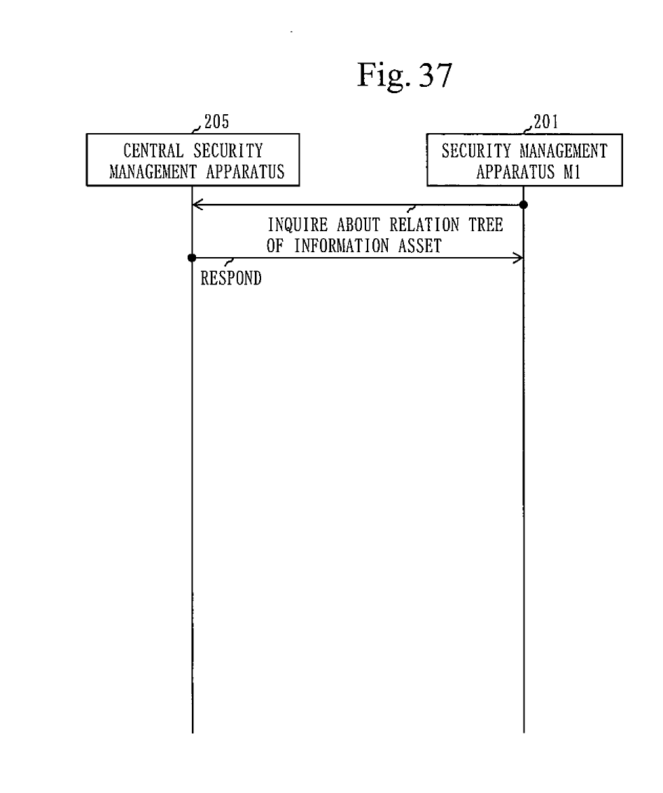

In step S335 of FIG. 35, the second communication unit 411 of the security management apparatus M1 inquires of the central security management apparatus 205 about the relation tree 414 of the information asset A11. According to a communication procedure illustrated in FIG. 37, in step S351 of FIG. 39, the communication unit 607 of the central security management apparatus 205 receives the inquiry about the relation tree 414 of the information asset A11 from the security management apparatus M1. In step S352 of FIG. 39, the communication unit 607 of the central security management apparatus 205 transmits the relation tree 414 of the information asset A11 stored in the memory 602, to the security management apparatus M1.

In step S336 of FIG. 35, the second communication unit 411 of the security management apparatus M1 receives the relation tree 414 of the information asset A11. In step S337 of FIG. 35, a calculation unit 418 of the security management apparatus M1 sets an actual threat content 513 and an actual measure content 515 and calculates an impact degree 520 of a security measure, based on the received relation tree 414 of the information asset A11 and based on the candidates for a security measure extracted by the extraction unit 408. Then, the calculation unit 418 generates a security measure evaluation table 511 including the actual threat content 513, the actual measure content 515, and the impact degree 520 of a security measure.

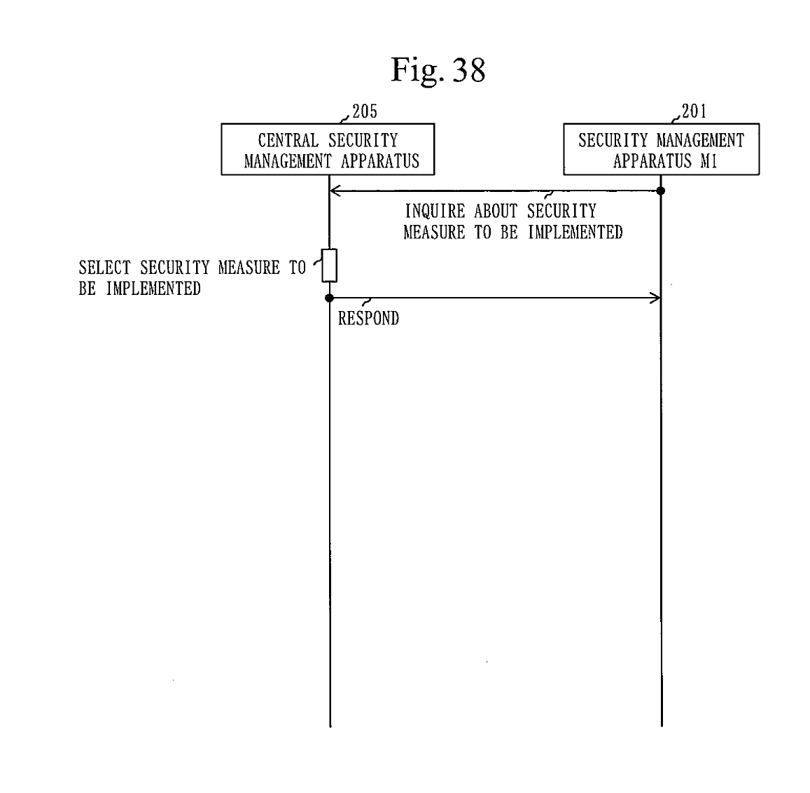

In step S338 of FIG. 35, the second communication unit 411 of the security management apparatus M1 transmits the generated security measure evaluation table 511 to the central security management apparatus 205, and inquires about a security measure to be implemented. According to a communication procedure illustrated in FIG. 38, in step S361 of FIG. 40, the communication unit 607 of the central security management apparatus 205 receives the inquiry from the security management apparatus M1 about a security measure to be implemented. In step S362 of FIG. 40, the selection unit 613 of the central security management apparatus 205 selects a security measures to be implemented from the received security measure evaluation table 511, based on the relation tree 414, the system status information 614, and the security measure policy 419 that are stored in the memory 602. In step S363 of FIG. 40, the communication unit 607 of the central security management apparatus 205 transmits a response indicating the determined security measures to be implemented, to the security management apparatus M1.

In step S339 of FIG. 35, the second communication unit 411 of the security management apparatus M1 receives the response indicating the security measures to be implemented, from the central security management apparatus 205. In step S340 of FIG. 35, in accordance with a security measure policy specified by an administrator, a selection unit 415 of the security management apparatus M1 selects an optimum security measure from among the received security measures to be implemented.

In step S341 of FIG. 35, an implementation unit 416 of the security management apparatus M1 implements the optimum security measure selected by the selection unit 415. It should be noted that, depending on an optimum security measure, the optimum security measure cannot be automatically implemented by the security management apparatus M1, and, are implemented by an administrator in that case.

*** Description of Effect of Embodiment ***

As described above, in the present embodiment, similarly to that in the second embodiment, by obtaining a dependence relation with other system from a connection of the information assets 203, and obtaining, from the dependence relation with other system, an impact on other system caused by a security measure, it is possible to select and implement an optimum security measure considering an impact degree caused by the security measure. Therefore, it is possible to realize a safe security measure system in which a measure implemented in a certain system does not cause serious damage to other system.

In the present embodiment, the central security management apparatus 205 aggregates the dependency information 412 from the security management apparatus M1 corresponding to the security management apparatus 201 included in the first system 101, and from the security management apparatuses M2 and M3 corresponding to other security management apparatus 201 included in the one or more second systems 102. Specifically, in step S321, the communication unit 607 of the central security management apparatus 205 receives, from the external security management apparatuses M1, M2, and M3, dependency information 412 indicating a dependence relation among the information assets 203 individually held by the system X1 corresponding to the first system 101 and by the systems X2 and X3 corresponding to the second systems 102. Then, in step S362, the selection unit 613 of the central security management apparatus 205 selects, from candidates for a security measure against a threat to the information asset A11 held by the system X1, a security measure to be implemented in accordance with the dependence relation indicated by the dependency information 412 received by the communication unit 607.

As described above, in the present embodiment, from the candidates for a security measure for the information asset A11 held by the system X1, a security measure to be implemented is selected in accordance with the dependence relation among the information assets 203 individually held by the systems X1, X2, and X3. Therefore, similarly to the first embodiment, as a security measure to be implemented in the system X1, it is possible to select a security measure that does not cause a large impact on the systems X2 and X3.

In step S323, the generation unit 611 of the central security management apparatus 205 generates a relation tree 414, which is data to define the dependence relation indicated by the dependency information 412 in a tree structure, from the dependency information 412. In step S362, the selection unit 613 of the central security management apparatus 205 refers to the relation tree 414 generated by the generation unit 611 and specifies a dependence relation among the information assets 203 individually held by the systems X1, X2, and X3. Since the dependence relation can be specified by scanning of the tree structure, efficient processing is possible.

*** Other Configuration ***

In the present embodiment, as in the first embodiment, the function of the “unit” of the security management apparatus 201 is realized by software. However, as in the modification of the first embodiment, the function of the “unit” of the security management apparatus 201 may be realized by a combination of software and hardware.

### Fourth Embodiment

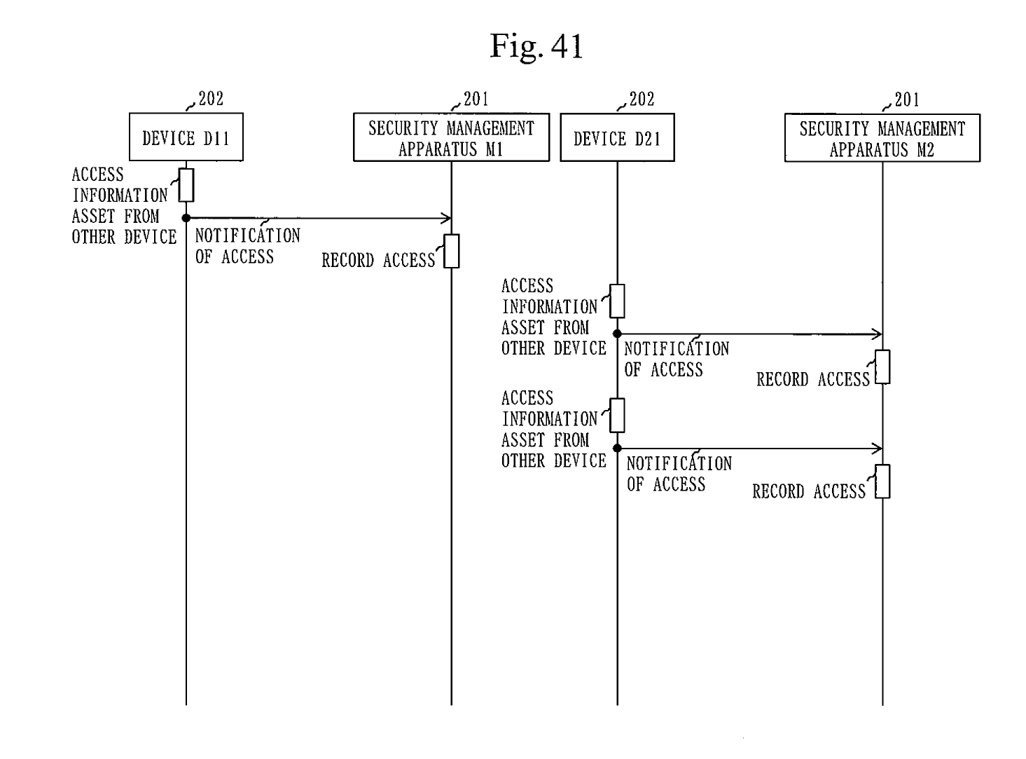

For the present embodiment, a difference from the second embodiment will be mainly described by using to FIGS. 41 to 47.

*** Description of Configuration ***

A configuration of a SoS 100 according to the present embodiment is the same as that of the first embodiment illustrated in FIG. 2. That is, in the present embodiment, unlike the second embodiment, the SoS 100 does not include a central security management apparatus 205.

In the present embodiment, when a security management apparatus 201 of a first system 101 checks an impact caused by a security measure on other system corresponding to a second system 102, an optimum security measure is selected and implemented by recursively inquiring of other system about a dependence relation with other system. A difference from the second embodiment is that there is no central security management apparatus 205 and that the security management apparatus 201 cooperatively operates to obtain the dependence relation with other system.

A configuration of the security management apparatus 201 according to the present embodiment is similar to that of the second embodiment illustrated in FIG. 14.

*** Description of Operation ***

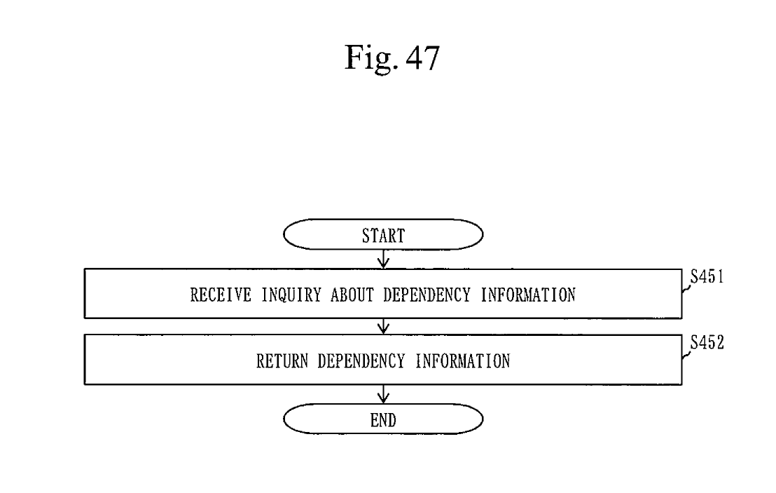

With reference to FIGS. 41 and 47, an operation of the SoS 100 according to the present embodiment will be described. An operation of the security management apparatus 201 according to the present embodiment corresponds to a security management method according to the present embodiment. The operation of the security management apparatus 201 according to the present embodiment corresponds to a processing procedure of a security management program according to the present embodiment.

FIG. 41 illustrates that reference to an information asset 203 is made in the following order, but the order of reference is not limited to this. First, an information asset A21 on a device D21 of a system X2 refers to an information asset A11 on a device D11 of a system X1. Next, an information asset A22 on a device D22 of the system X2 refers to the information asset A21 on the device D21 of the system X2. Finally, an information asset A31 on a device D31 of a system X3 refers to the information asset A21 on the device D21 of the system X2.

Dependency information 412 transmitted and received between a device 202 and the security management apparatus 201 and between the security management apparatuses 201 includes, similarly to that in the second embodiment, information asset information of a reference source, information asset information of a reference destination, and an importance of the information asset of the reference destination in the information asset of the reference source.

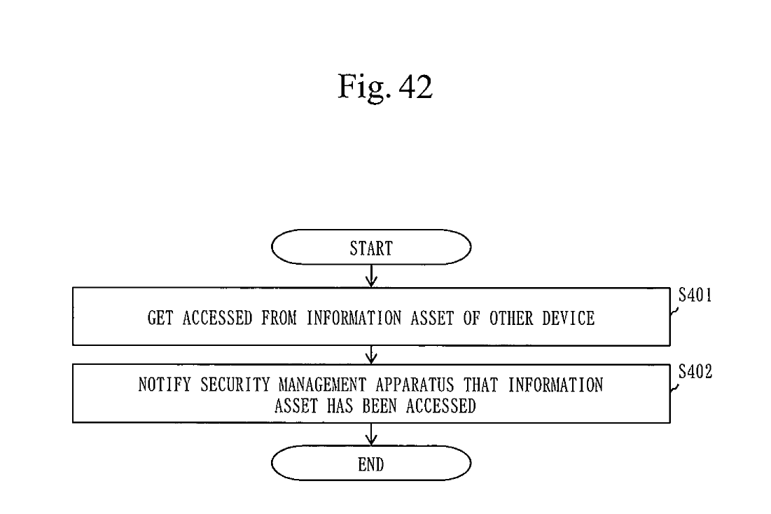

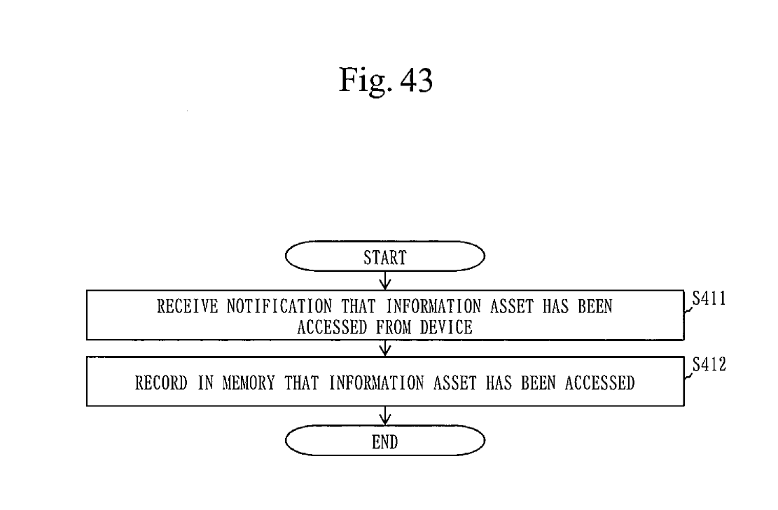

FIG. 42 illustrates an operation of the device 202. FIG. 43 illustrates an operation at a time when the security management apparatus 201 receives a notification, from the device 202, that the information asset 203 has been accessed.

In step S401 of FIG. 42, in order to refer to the information asset A11 on the device D11 of the system X1, the information asset A21 on the device D21 of the system X2 accesses the information asset A11. In step S402 of FIG. 42, a communication unit 307 of the device D11 notifies a security management apparatus M1 of the system X1 that the information asset A11 has been accessed from the device D21 of the system X2.

In step S411 of FIG. 43, a first communication unit 410 of the security management apparatus M1 receives a notification from the device D11 that the information asset A11 has been accessed. In step S412 of FIG. 43, the security management apparatus M1 stores, in a memory 402, a record that the information asset A11 has been accessed from the device D21 of the system X2.

Similarly, in step S401 of FIG. 42, in order to refer to the information asset A21 on the device D21 of the system X2, the information asset A22 on the device D22 of the system X2 accesses the information asset A21. In step S402 of FIG. 42, a communication unit 307 of the device D21 notifies a security management apparatus M2 of the system X2 that the information asset A21 has been accessed from the device D22 of the system X2.

In step S411 of FIG. 43, a first communication unit 410 of the security management apparatus M2 receives a notification from the device D21 that the information asset A21 has been accessed. In step S412 of FIG. 43, the security management apparatus M2 stores, in a memory 402, a record that the information asset A21 has been accessed from the device D22 of the system X2.

Similarly, in step S401 of FIG. 42, in order to refer to the information asset A21 on the device D21 of the system X2, the information asset A31 on the device D31 of the system X3 accesses the information asset A21. In step S402 of FIG. 42, the communication unit 307 of the device D21 notifies the security management apparatus M2 of the system X2 that the information asset A21 has been accessed from the device D31 of the system X3.

In step S411 of FIG. 43, the first communication unit 410 of the security management apparatus M2 receives a notification from the device D21 that the information asset A21 has been accessed. In step S412 of FIG. 43, the security management apparatus M2 stores, in the memory 402, a record that the information asset A21 has been accessed from the device D31 of the system X3.

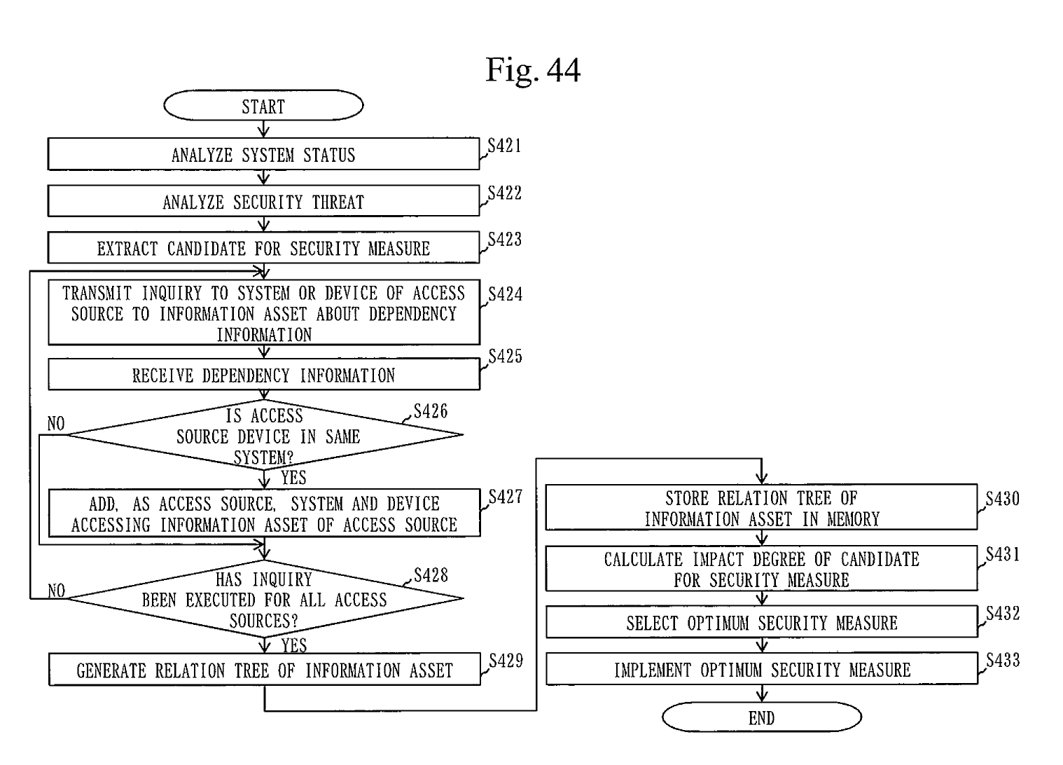

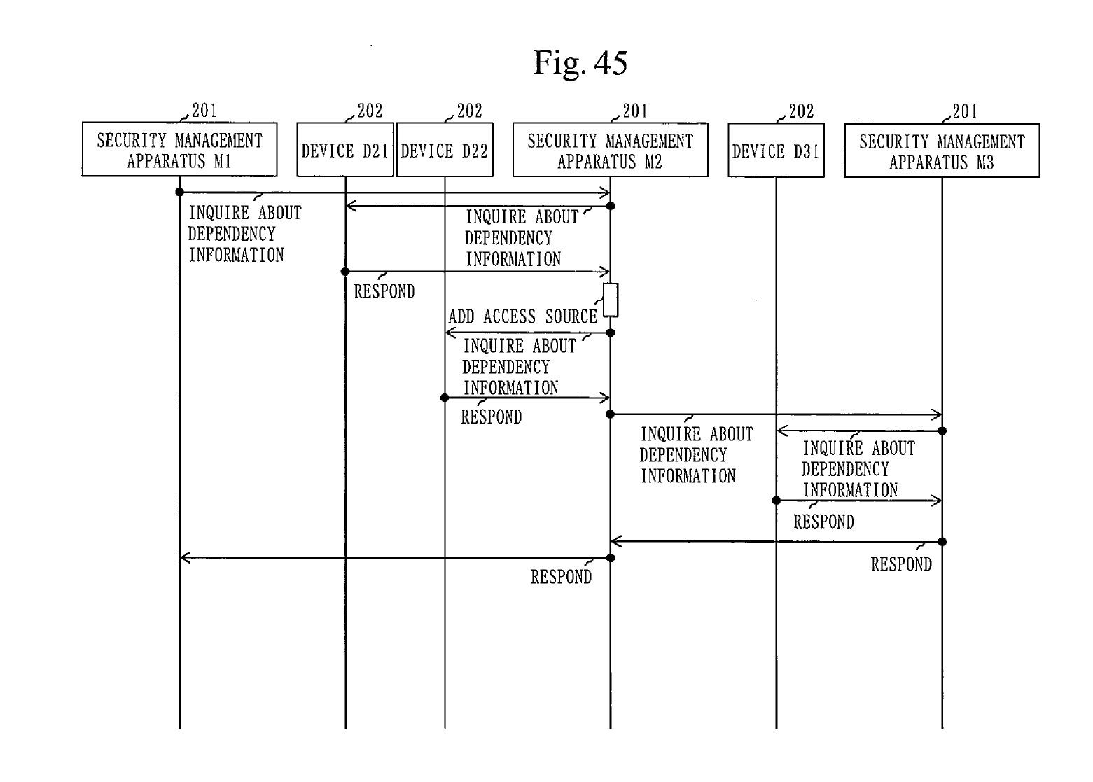

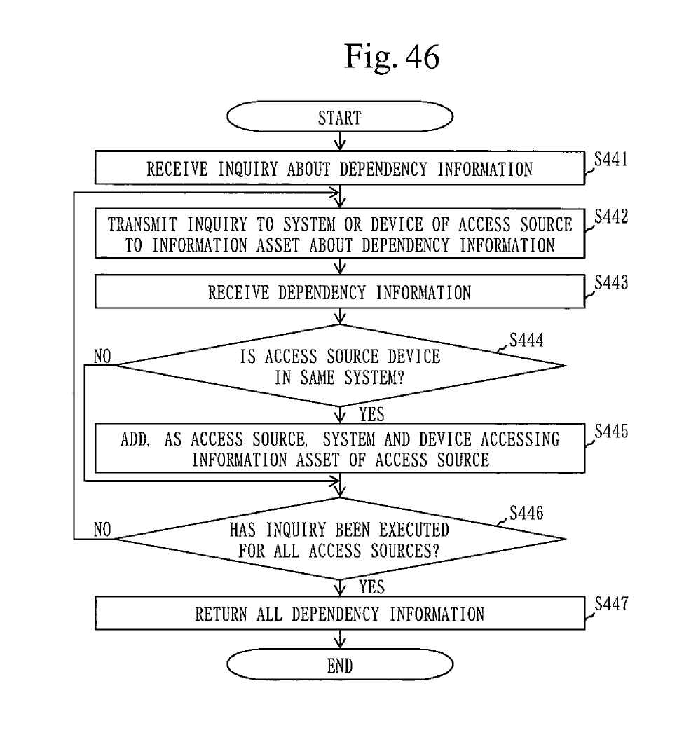

FIG. 44 illustrates an operation at a time when the security management apparatus 201 performs security threat analysis and implements a security measure. During this operation, a communication as illustrated in FIG. 45 is performed between the security management apparatuses 201. FIG. 46 illustrates an operation at a time when the security management apparatus 201 receives an inquiry about the dependency information 412 from a security management apparatus 201 of other system. FIG. 47 illustrates an operation at a time when the device 202 receives the inquiry about the dependency information 412 from the security management apparatus 201.

Since processing from step S421 to step S423 in FIG. 44 is the same as processing from step S131 to step S133 in FIG. 11, the description will be omitted. Here again, it is assumed that the analysis unit 406 has found a threat of an unauthorized access to the information asset A11 on the device D11 of the system X1.

Next, the security management apparatus M1 collects the dependency information 412 on an access to the information asset A11 where a threat has been found. Specifically, in step S424 of FIG. 44, the security management apparatus M1 identifies that the device D21 of the system X2 is accessing the information asset A11, based on the record stored in the memory 402. Accordingly, a second communication unit 411 of the security management apparatus M1 transmits, to the security management apparatus M2 of the system X2, an inquiry about the dependency information 412 on the access to the information asset A11 from the device D21. According to a communication procedure of FIG. 45, in step S441 of FIG. 46, a second communication unit 411 of the security management apparatus M2 of the system X2 receives the inquiry from the security management apparatus M1 about the dependency information 412 on the access to the information asset A11. In step S442 of FIG. 46, the first communication unit 410 of the security management apparatus M2 transmits the inquiry to the device D21 about the dependency information 412 on the access to the information asset A11.

In step S451 of FIG. 47, the communication unit 307 of the device D21 receives the inquiry about the dependency information 412 on the access to the information asset A11. In step S452 of FIG. 47, the communication unit 307 of the device D21 transmits, as a response to the inquiry, dependency information 412 “information asset A21 @ system X2 to information asset A11 @ system X1” and “C: 1, I: 3, A: 3” to the security management apparatus M2.

In step S443 of FIG. 46, the first communication unit 410 of the security management apparatus M2 receives the dependency information 412 “information asset A21 @ system X2 to information asset A11 @ system X1” and “C: 1, I: 3, A: 3”. In step S444 of FIG. 46, the security management apparatus M2 determines whether or not an access source to the information asset A11 is the device 202 in the same system X2 as the security management apparatus M2. In this case, the access source to the information asset A11 is the device D21 in the same system X2. Therefore, in step S445 of FIG. 46, the security management apparatus M2 identifies that the device D22 of the system X2 and the device D31 of the system X3 are accessing the information asset A21 of the device D21, based on the record stored in the memory 402. Accordingly, the security management apparatus M2 adds the device D22 of the system X2 and the device D31 of the system X3 to a temporary list, as an access source to the information asset A21.

In step S446 of FIG. 46, the security management apparatus M2 checks whether or not the inquiry about the dependency information 412 has been executed for all access sources. In this case, inquiries to the device D22 and the device D31 are left.

In step S442 of FIG. 46, the first communication unit 410 of the security management apparatus M2 transmits the inquiry to the device D22 about the dependency information 412 on an access to the information asset A21.

In step S451 of FIG. 47, a communication unit 307 of the device D22 receives the inquiry about the dependency information 412 on the access to the information asset A21. In step S452 of FIG. 47, the communication unit 307 of the device D22 transmits, as a response to the inquiry, dependency information 412 “information asset A22 @ system X2 to information asset A21 @ system X2” and “C: 3, I: 3, A: 2” to the security management apparatus M2.

In step S443 of FIG. 46, the first communication unit 410 of the security management apparatus M2 receives the dependency information 412 “information asset A22 @ system X2 to information asset A21 @ system X2” and “C: 3, I: 3, A: 2”. In step S444 of FIG. 46, the security management apparatus M2 determines whether or not the access source to the information asset A21 is the device 202 in the same system X2 as the security management apparatus M2. In this case, the access source to the information asset A21 is the device D22 in the same system X2. Therefore, in step S445 of FIG. 46, the security management apparatus M2 identifies that the information asset A22 of the device D22 has not been accessed, based on the record stored in the memory 402. Therefore, the security management apparatus M2 does not need to add the access source to the information asset A22, to the temporary list.

In step S446 of FIG. 46, the security management apparatus M2 checks whether or not the inquiry about the dependency information 412 has been executed for all access sources. In this case, an inquiry to the device D31 is left.

In step S442 of FIG. 46, the first communication unit 410 of the security management apparatus M2 transmits, to a security management apparatus M3 of the system X3, an inquiry about the dependency information 412 on the access to the information asset A21 from the device D31. According to the communication procedure of FIG. 45, in step S441 of FIG. 46, a second communication unit 411 of the security management apparatus M3 of the system X3 receives the inquiry from the security management apparatus M2 about the dependency information 412 on the access to the information asset A21. In step S442 of FIG. 46, a first communication unit 410 of the security management apparatus M3 transmits the inquiry to the device D31 about the dependency information 412 on the access to the information asset A21.

In step S451 of FIG. 47, a communication unit 307 of the device D31 receives the inquiry about the dependency information 412 on the access to the information asset A21. In step S452 of FIG. 47, the communication unit 307 of the device D31 transmits, as a response to the inquiry, dependency information 412 “information asset A31 @ system X3 to information asset A21 @ system X2” and “C: 1, I: 3, A: 3” to the security management apparatus M3.

In step S443 of FIG. 46, the first communication unit 410 of the security management apparatus M3 receives the dependency information 412 “information asset A31 @ system X3 to information asset A21 @ system X2” and “C: 1, I: 3, A: 3”. In step S444 of FIG. 46, the security management apparatus M3 determines whether or not the access source to the information asset A21 is the device 202 in the same system X3, as the security management apparatus M3. In this case, the access source to the information asset A21 is the device D31 in the same system X3. Therefore, in step S445 of FIG. 46, the security management apparatus M3 identifies that the information asset A31 of the device D31 has not been accessed, based on the record stored in the memory 402. Therefore, the security management apparatus M3 does not need to add an access source to the information asset A31, to the temporary list.

In step S446 of FIG. 46, the security management apparatus M3 checks whether or not the inquiry about the dependency information 412 has been executed for all access sources. In this case, inquiry about dependency information 412 on the access has been executed to all access sources. Therefore, in step S447 of FIG. 46, the second communication unit 411 of the security management apparatus M3 transmits the obtained dependency information 412 “information asset A31 @ system X3 to information asset A21 @ system X2” and “C: 1, I: 3, A: 3” to the security management apparatus M2.

In step S443 of FIG. 46, the first communication unit 410 of the security management apparatus M2 receives the dependency information 412 “information asset A31 @ system X3 to information asset A21 @ system X2” and “C: 1, I: 3, A: 3”. In step S444 of FIG. 46, the security management apparatus M2 determines whether or not the access source to the information asset A21 is the device 202 in the same system X2 as the security management apparatus M2. In this case, the access source to the information asset A21 is the device D31 in the system X3. Therefore, processing of step S445 of FIG. 46 is skipped.

In step S446 of FIG. 46, the security management apparatus M2 checks whether or not the inquiry about the dependency information 412 has been executed for all access sources. In this case, inquiry about dependency information 412 on the access has been executed to all access sources. Therefore, in step S447 of FIG. 46, the second communication unit 411 of the security management apparatus M2 transmits, to the security management apparatus M1, the obtained dependency information 412 “information asset A21 @ system X2 to information asset A11 @ system X1” and “C: 1, I: 3, A: 3”; the dependency information 412 “information asset A22 @ system X2 to information asset A21 @ system X2” and “C: 3, I: 3, A: 2”; and the dependency information 412 “information asset A31 @ system X3 to information asset A21 @ system X2” and “C: 1, I: 3, A: 3”.

Here, for an information asset 203 that is not referred to from an information asset 203 of other system and does not refer to an information asset 203 of other system, the security management apparatus 201 does not need to individually transmit the dependency information 412. Then, the security management apparatus 201 may add an importance of this information asset 203 to an importance of an information asset 203 referring to an information asset 203 of other system, to provide a notification. Specifically, in the present embodiment, the information asset A22 on the device D22 of the system X2 is not referred to from an information asset 203 of other system, and does not refer to an information asset 203 of other system. Accordingly, the security management apparatus M2 adds the importance “C: 3, I: 3, A: 2” of the information asset A21 in the information asset A22 to the importance “C: 1, I: 3, A: 3” of the information asset A11 in the information asset A21, and notifies the security management apparatus M1 of the importance of the information asset A11 in the information asset A21 as “C: 4, I: 6, A: 5”. That is, to the security management apparatus M1, the security management apparatus M2 transmits: the dependency information 412 “information asset A21 @ system X2 to information asset A11 @ system X1” and “C: 4, I: 6, A: 5”; and the dependency information 412 “information asset A31 @ system X3 to information asset A21 @ system X2” and “C: 1, I: 3, A: 3”.

In step S425 of FIG. 44, the second communication unit 411 of the security management apparatus M1 receives: the dependency information 412 “information asset A21 @ system X2 to information asset A11 @ system X1” and “C: 1, I: 3, A: 3”; the dependency information 412 “information asset A22 @ system X2 to information asset A21 @ system X2” and “C: 3, I: 3, A: 2”; and the dependency information 412 “information asset A31 @ system X3 to information asset A21 @ system X2” and “C: 1, I: 3, A: 3”, from the security management apparatus M2. In step S426 of FIG. 44, the security management apparatus M1 determines whether or not the access source to the information asset A11 is the device 202 in the same system X1, as the security management apparatus M1. In this case, the access source to the information asset A11 is the device D21 in the system X2. Therefore, processing of step S427 of FIG. 44 is skipped.

In step S428 of FIG. 44, the security management apparatus M1 checks whether or not the inquiry about the dependency information 412 has been executed for all access sources. In this case, inquiry about dependency information 412 on the access has been executed to all access sources. Therefore, in step S429 of FIG. 46, a generation unit 413 of the security management apparatus M1 generates a relation tree 414 of the information asset 203 based on the dependency information 412 received by the second communication unit 411. In step S430 of FIG. 46, the generation unit 413 of the security management apparatus M1 stores the relation tree 414 in the memory 402. Since processing of step S431 and step S432 of FIG. 44 is the same as processing of step S266 and step S267 of FIG. 26, the description will be omitted.

In step S433 of FIG. 44, an implementation unit 416 of the security management apparatus M1 implements the optimum security measure selected by a selection unit 415. It should be noted that, depending on an optimum security measure, the optimum security measure cannot be automatically implemented by the security management apparatus M1, and, are implemented by an administrator in that case.

*** Description of Effect of Embodiment ***

As described above, in the present embodiment, similarly to that in the second embodiment, by obtaining a dependence relation with other system from a connection of the information assets 203, and obtaining, from the dependence relation with other system, an impact on other system caused by a security measure, it is possible to select and implement an optimum security measure considering an impact degree caused by the security measure. Therefore, it is possible to realize a safe security measure system in which a measure implemented in a certain system does not cause serious damage to other system.

Although the embodiments of the present invention have been described above, two or more embodiments among these embodiments may be combined to be implemented. Alternatively, one of these embodiments or a combination of two or more of these embodiments may be partially implemented. It should be noted that the present invention is not limited to these embodiments, and various modifications are possible as required.

### REFERENCE SIGNS LIST

100: SoS, 101: first system, 102: second system, 103: Internet, 201: security management apparatus, 202: device, 203: information asset, 204a: LAN, 204b: LAN, 204c: LAN, 205: central security management apparatus, 301: processor, 302: memory, 303: auxiliary storage device, 304: communication module, 305: input/output interface, 306: bus, 307: communication unit, 401: processor, 402: memory, 403: auxiliary storage device, 404: input/output interface, 405: detection unit, 406: analysis unit, 407: database, 408: extraction unit, 409: bus, 410: first communication unit, 411: second communication unit, 412: dependency information, 413: generation unit, 414: relation tree, 415: selection unit, 416: implementation unit, 417: communication module, 418: calculation unit, 419: security measure policy, 501: security measure list, 502: threat ID, 503: threat content, 504: measure ID, 505: measure content, 506: introduction cost, 507: operation cost, 508: after-measure attack occurrence frequency, 509: after-measure attack success rate, 510: impact degree calculation expression, 511: security measure evaluation table, 512: threat ID, 513: threat content, 514: measure ID, 515: measure content, 516: introduction cost, 517: operation cost, 518: after-measure attack occurrence frequency, 519: after-measure attack success rate, 520: impact degree, 601: processor, 602: memory, 603: auxiliary storage device, 604: communication module, 605: input/output interface, 606: bus, 607: communication unit, 610: device list, 611: generation unit, 613: selection unit, 614: system status information.

1. A security management apparatus, which is included in a first system, comprising:
processing circuitry to:
externally receive dependency information indicating a dependence relation among information assets individually held by the first system and one or more second systems different from the first system; and
select a security measure to be implemented from candidates for a security measure against a threat to a first information asset that is an information asset held by the first system, in accordance with an impact degree, caused by a security measure, on a second information asset that is an information asset dependent on the first information asset indicated by the dependency information received by the communication unit.

2. The security management apparatus according to claim 1, wherein the processing circuitry
selects, as a security measure to be implemented, a security measure that is to limit an access source to the first information asset, to a second system holding the second information asset.

3. The security management apparatus according to claim 1, wherein the processing circuitry
generates a relation tree that is data to define the dependence relation in a tree structure, from the dependency information, and
refers to a relation tree generated by the generation unit to specify the second information asset.

4. The security management apparatus according to claim 1, wherein
the dependency information includes information indicating an importance of an information asset of the first information asset with respect to an information asset of a dependent source,
wherein the processing circuitry calculates the impact degree, caused by a security measure, on the second information asset from an importance indicated with the dependency information.

5. The security management apparatus according to claim 1, wherein the processing circuitry
extracts, for each security measure, an index value of each of the candidates from a database storing an index values for selecting a security measure, and
selects, as a security measure to be implemented, a security measure whose index value extracted by the extraction unit satisfies a condition.

6. The security management apparatus according to claim 5, wherein the processing circuitry externally receives information indicating the condition.

7. The security management apparatus according to claim 1, wherein the processing circuitry
detects a change in a configuration of the first system, and
selects a security measure to be implemented among candidates for a security measure against a threat extracted, as the candidates, in accordance with a change detected by the detection unit.

8. The security management apparatus according to claim 1, wherein
the security management apparatus shares the dependency information with other security management apparatus included in the one or more second systems.

9. A central security management apparatus for aggregating the dependency information from the security management apparatus according to claim 1, and from other security management apparatus included in the one or more second systems.

10. A security management method comprising:
externally receiving, by a communication unit of a first system, dependency information indicating a dependence relation among information assets individually held by the first system and one or more second systems different from the first system; and
selecting, by a selection unit of a first system, a security measure to be implemented from candidates for a security measure against a threat to a first information asset that is an information asset held by the first system, in accordance with an impact degree, caused by a security measure, on a second information asset that is an information asset dependent on the first information asset indicated by the dependency information received by the communication unit.

11. A non-transitory computer readable medium storing security management program for causing
a computer, included in a first system, to execute:
processing for externally receiving dependency information indicating a dependence relation among information assets individually held by the first system and one or more second systems different from the first system; and
processing for selecting a security measure to be implemented from candidates for a security measure against a threat to a first information asset that is an information asset held by the first system, in accordance with an impact degree, caused by a security measure, on a second information asset that is an information asset dependent on the first information asset indicated by the dependency information.

12. The security management apparatus according to claim 2, wherein the processing circuitry
generates a relation tree that is data to define the dependence relation in a tree structure, from the dependency information, and
refers to a relation tree generated by the generation unit to specify the second information asset.

13. The security management apparatus according to claim 2, wherein
the dependency information includes information indicating an importance of an information asset of the first information asset with respect to an information asset of a dependent source,
wherein the processing circuitry calculates the impact degree, caused by a security measure, on the second information asset from an importance indicated with the dependency information.

14. The security management apparatus according to claim 3, wherein
the dependency information includes information indicating an importance of an information asset of the first information asset with respect to an information asset of a dependent source,
wherein the processing circuitry calculates the impact degree, caused by a security measure, on the second information asset from an importance indicated with the dependency information.

15. The security management apparatus according to claim 2, wherein the processing circuitry
extracts, for each security measure, an index value of each of the candidates from a database storing an index values for selecting a security measure, and
selects, as a security measure to be implemented, a security measure whose index value extracted by the extraction unit satisfies a condition.

16. The security management apparatus according to claim 3, wherein the processing circuitry
extracts, for each security measure, an index value of each of the candidates from a database storing an index values for selecting a security measure, and
selects, as a security measure to be implemented, a security measure whose index value extracted by the extraction unit satisfies a condition.

17. The security management apparatus according to claim 4, wherein the processing circuitry
extracts, for each security measure, an index value of each of the candidates from a database storing an index values for selecting a security measure, and
selects, as a security measure to be implemented, a security measure whose index value extracted by the extraction unit satisfies a condition.

18. The security management apparatus according to claim 2, wherein the processing circuitry
detects a change in a configuration of the first system, and
selects a security measure to be implemented among candidates for a security measure against a threat extracted, as the candidates, in accordance with a change detected by the detection unit.

19. The security management apparatus according to claim 3, wherein the processing circuitry
detects a change in a configuration of the first system, and
selects a security measure to be implemented among candidates for a security measure against a threat extracted, as the candidates, in accordance with a change detected by the detection unit.

20. The security management apparatus according to claim 4, wherein the processing circuitry
detects a change in a configuration of the first system, and
selects a security measure to be implemented among candidates for a security measure against a threat extracted, as the candidates, in accordance with a change detected by the detection unit.
